(19) United States
(12) Patent Application Publication
(10) Pub. No.: US 2013/0150035 A1
(43) Pub. Date: Jun. 13, 2013

(54) METHOD AND APPARATUS FOR CLASSIFYING NEIGHBORING DEVICES

(71) Applicants: Vinay CHANDE, San Diego, CA (US); Farhad Meshkati, San Diego, CA (US); Damanjit Singh, San Diego, CA (US); Satashu Goel, San Diego, CA (US); Sumeeth Nagaraja, San Diego, CA (US); Andrei Dragos Radulescu, San Diego, CA (US); Mehmet Yavuz, San Diego, CA (US)

(72) Inventors: Vinay CHANDE, San Diego, CA (US); Farhad Meshkati, San Diego, CA (US); Damanjit Singh, San Diego, CA (US); Satashu Goel, San Diego, CA (US); Sumeeth Nagaraja, San Diego, CA (US); Andrei Dragos Radulescu, San Diego, CA (US); Mehmet Yavuz, San Diego, CA (US)

(73) Assignee: QUALCOMM Incorporated, San Diego, CA (US)

(21) Appl. No.: 13/450,913

(22) Filed: Apr. 19, 2012

Related U.S. Application Data
(60) Provisional application No. 61/477,938, filed on Apr. 21, 2011.

(51) Int. Cl. H04W 24/02

(52) U.S. Cl. CPC H04W 24/02
USPC 455/435.1

(57) ABSTRACT

Methods and apparatuses are provided that include classifying nearby devices as neighboring or non-neighboring devices. Devices can be classified based on detected registration attempts to a femto node, where the femto node can switch paging area identifiers to cause the registration attempts or otherwise, analyzing measurement reports received from the devices in a registration request, and/or the like. The femto node can mitigate interference to the devices based on the classification.

### CLAIM OF PRIORITY UNDER 35 U.S.C. §119

The present application for patent claims priority to Provisional Application No. 61/477,938, entitled “METHOD AND APPARATUS FOR CLASSIFYING NEIGHBORING DEVICES” filed Apr. 21, 2011, assigned to the assignee hereof and hereby expressly incorporated by reference herein.

### BACKGROUND

1. Field

The following description relates generally to wireless network communications, and more particularly to classifying neighboring devices at a femto node.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP) (e.g., 3GPP LTE (Long Term Evolution)/LTE-Advanced), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth.

To supplement conventional base stations, additional restricted base stations can be deployed to provide more robust wireless coverage to mobile devices. For example, wireless relay stations and low power base stations (e.g., which can be commonly referred to as Home NodeBs or Home eNBs, collectively referred to as H(e)NBs, femto nodes, pico nodes, etc.) can be deployed for incremental capacity growth, richer user experience, in-building or other specific geographic coverage, and/or the like. Such low power base stations can be connected to the Internet via broadband connection (e.g., digital subscriber line (DSL) router, cable or other modem, etc.), which can provide the backhaul link to the mobile operator's network. Thus, for example, the low power base stations can be deployed in user homes to provide mobile network access to one or more devices via the broadband connection. In an example, such low power base stations can interfere with one or more devices communicating with another base station.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, the present disclosure describes various aspects in connection with determining a classification for devices near a femto node or other low power base station. The femto node can manage interference experienced by the devices based on the classification. In an example, the femto node can classify the devices as one of a neighboring device that spends a substantial amount of time near the femto node, a passer-by device that is within the presence of the femto node for a brief period of time, and/or varying levels in between. The femto node can take various actions to mitigate interference to the devices based on the classification. For example, if a device is a neighboring device, the femto node can take more drastic measures to avoid interfering the device than for passer-by devices.

According to an aspect, a method for classifying user equipment (UE) at a femto node is provided that includes temporarily modifying an advertised paging area identifier of a femto node for a plurality of durations of time to cause one or more UEs to attempt registration and determining a number of registration requests received from at least one of the one or more UEs during the plurality of durations of time. The method further includes classifying the at least one UE as a neighboring UE or a non-neighboring UE of the femto node based in part on the number of registration requests.

In another aspect, an apparatus for apparatus for classifying UE at a femto node is provided. The apparatus includes at least one processor configured to temporarily modify an advertised paging area identifier of a femto node for a plurality of durations of time to cause one or more UEs to attempt registration and determine a number of registration requests received from at least one of the one or more UEs during the plurality of durations of time. The at least one processor is further configured to classify the at least one UE as a neighboring UE or a non-neighboring UE of the femto node based in part on the number of registration requests. The apparatus further includes a memory coupled to the at least one processor.

In yet another aspect, an apparatus for classifying UE at a femto node is provided. The apparatus includes means for temporarily modifying an advertised paging area identifier of a femto node for a plurality of durations of time to cause one or more UEs to attempt registration and means for determining a number of registration requests received from at least one of the one or more UEs during the plurality of durations of time. The apparatus further includes means for classifying the at least one UE as a neighboring UE or a non-neighboring UE of the femto node based in part on the number of registration requests.

Still, in another aspect, a computer-program product for classifying UE at a femto node is provided including a non-transitory computer-readable medium having code for causing at least one computer to temporarily modify an advertised paging area identifier of a femto node for a plurality of durations of time to cause one or more UEs to attempt registration. The computer-readable medium further includes code for causing the at least one computer to determine a number of registration requests received from at least one of the one or more UEs during the plurality of durations of time and code for causing the at least one computer to classify the at least one UE as a neighboring UE or a non-neighboring UE of the femto node based in part on the number of registration requests.

Moreover, in an aspect, an apparatus for classifying UE at a femto node is provided that includes an identifier modifying component for temporarily modifying an advertised paging area identifier of a femto node for a plurality of durations of time to cause one or more UEs to attempt registration and a UE registration receiving component for determining a number of registration requests received from at least one of the one or more UEs during the plurality of durations of time. The apparatus further includes a UE classifying component for classifying the at least one UE as a neighboring UE or a non-neighboring UE of the femto node based in part on the number of registration requests.

In another aspect, a method for classifying UE at a femto node is provided that includes measuring one or more time intervals between a plurality of registration requests received from a UE at a femto node and classifying the UE as a neighboring UE or a non-neighboring UE of the femto node based in part on comparing the one or more time intervals.

In another aspect, an apparatus for apparatus for classifying UE at a femto node is provided. The apparatus includes at least one processor configured to measure one or more time intervals between a plurality of registration requests received from a UE at a femto node and classify the UE as a neighboring UE or a non-neighboring UE of the femto node based in part on comparing the one or more time intervals. The apparatus further includes a memory coupled to the at least one processor.

In yet another aspect, an apparatus for classifying UE at a femto node is provided. The apparatus includes means for measuring one or more time intervals between a plurality of registration requests received from a UE at a femto node. The apparatus further includes means for classifying the UE as a neighboring UE or a non-neighboring UE of the femto node based in part on comparing the one or more time intervals.

Still, in another aspect, a computer-program product for classifying UE at a femto node is provided including a non-transitory computer-readable medium having code for causing at least one computer to measure one or more time intervals between a plurality of registration requests received from a UE at a femto node. The computer-readable medium further includes code for causing the at least one computer to classify the UE as a neighboring UE or a non-neighboring UE of the femto node based in part on comparing the one or more time intervals.

Moreover, in an aspect, an apparatus for classifying UE at a femto node is provided that includes a UE registration receiving component for measuring one or more time intervals between a plurality of registration requests received from a UE at a femto node and a UE classifying component for classifying the UE as a neighboring UE or a non-neighboring UE of the femto node based in part on comparing the one or more time intervals.

According to yet another aspect, a method for classifying UE at a femto node is provided that includes receiving a measurement report in a connection request from a UE indicating a signal measurement of a femto node at the UE. The method further includes classifying the UE as a neighboring UE or a non-neighboring UE of the femto node based in part on the signal measurement in the measurement report.

In another aspect, an apparatus for apparatus for classifying UE at a femto node is provided. The apparatus includes at least one processor configured to receive a measurement report in a connection request from a UE indicating a signal measurement of a femto node at the UE and classify the UE as a neighboring UE or a non-neighboring UE of the femto node based in part on the signal measurement in the measurement report. The apparatus further includes a memory coupled to the at least one processor.

In yet another aspect, an apparatus for classifying UE at a femto node is provided. The apparatus includes means for receiving a measurement report in a connection request from a UE indicating a signal measurement of a femto node at the UE. The apparatus further includes means for classifying the UE as a neighboring UE or a non-neighboring UE of the femto node based in part on the signal measurement in the measurement report.

Still, in another aspect, a computer-program product for classifying UE at a femto node is provided including a non-transitory computer-readable medium having code for causing at least one computer to receive a measurement report in a connection request from a UE indicating a signal measurement of a femto node at the UE. The computer-readable medium further includes code for causing the at least one computer to classify the UE as a neighboring UE or a non-neighboring UE of the femto node based in part on the signal measurement in the measurement report.

Moreover, in an aspect, an apparatus for classifying UE at a femto node is provided that includes a measurement report receiving component for receiving a measurement report in a connection request from a UE indicating a signal measurement of a femto node at the UE. The apparatus further includes a UE classifying component for classifying the UE as a neighboring UE or a non-neighboring UE of the femto node based in part on the signal measurement in the measurement report.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of an example wireless communication system for classifying user equipment (UE) as neighboring or non-neighboring.

FIG. 2 is a block diagram of an example wireless communication system for classifying UEs based on switching a paging area identifier.

FIG. 3 is a block diagram of an example system for classifying UEs based on determining a time interval between registration attempts of the UE.

FIG. 4 is a block diagram of an example system for classifying UEs based on a measurement report received from the UE.

FIG. 5 is an example graph depicting pathloss of UEs with respect to a femto node.

FIG. 6 is an example graph depicting registrations of UEs with a femto node switching a paging area identifier.

FIG. 7 is an example graph depicting time intervals between registrations of UEs with a femto node.

FIG. 8 is an example graph depicting registration attempts of UEs with a femto node.

FIG. 9 is a flow chart of an aspect of an example methodology for classifying a UE based on switching a paging area identifier.

FIG. 10 is a flow chart of an aspect of an example methodology for classifying a UE based on time intervals between registration attempts.

FIG. 11 is a flow chart of an aspect of an example methodology for classifying a UE based on a measurement report received from the UE.

FIG. 12 is a block diagram of a system in accordance with aspects described herein.

FIG. 13 is a block diagram of an aspect of a system that classifies a UE based on switching a paging area identifier.

FIG. 14 is a block diagram of an aspect of a system that classifies a UE based on time intervals between registration attempts.

FIG. 15 is a block diagram of an aspect of a system that classifies a UE based on a measurement report received from the UE.

FIG. 16 is a block diagram of an aspect of a wireless communication system in accordance with various aspects set forth herein.

FIG. 17 is a schematic block diagram of an aspect of a wireless network environment that can be employed in conjunction with the various systems and methods described herein.

FIG. 18 illustrates an example wireless communication system, configured to support a number of devices, in which the aspects herein can be implemented.

FIG. 19 is an illustration of an exemplary communication system to enable deployment of femtocells within a network environment.

FIG. 20 illustrates an example of a coverage map having several defined tracking areas.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described further herein, a low power base station, such as a femto node, can classify nearby devices, not served by the femto node, to determine whether the devices are neighboring devices (e.g., the devices remain within proximity of the femto node for at least a threshold period of time), passer-by (or non-neighboring) devices that are within proximity of the femto node for a brief period of time, and/or varying levels in between. For example, a femto node can calibrate transmission power based at least in part on determining whether the devices are passer-by or neighboring devices in mitigating interference thereto. For example, the femto node can take more drastic measures to protect neighboring devices from femto node interference. In another example, the femto node can provide limited or complete access to neighboring devices, as opposed to passer-by devices.

In an example, a femto node can classify the devices based on detecting a number of registration attempts from the devices. For example, the femto node can temporarily change a paging area identifier, such as a location area code (LAC), routing area code (RAC), tracking area code (TAC), etc., to force registration from one or more devices. The femto node can consider devices to be neighboring devices where the devices attempt to register with the femto node at least a threshold number of times over a period of time based in the change in paging area identifier. In another example, the femto node can monitor an interval between registration attempts from a device to determine whether the interval is indicative of a neighboring device. In this example, the intervals can be evaluated to determine whether the intervals cluster around a similar value and/or around a forbidden list timer value. In yet another example, the femto node can request measurement reports related to the femto node from one or more devices, and the femto node can classify devices as neighboring devices where the devices report a higher channel quality at the time of registration than other devices.

A low power base station, as referenced herein, can include a femto node, a pico node, micro node, home Node B or home evolved Node B (H(e)NB), relay, and/or other low power base stations, and can be referred to herein using one of these terms, though use of these terms is intended to generally encompass low power base stations. For example, a low power base station transmits at a relatively low power as compared to a macro base station associated with a wireless wide area network (WWAN). As such, the coverage area of the low power base station can be substantially smaller than the coverage area of a macro base station.

As used in this application, the terms “component,” “module,” “system” and the like are intended to include a computer-related entity, such as but not limited to hardware, firmware, a combination of hardware and software, software, or software in execution, etc. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, terminal, communication device, user agent, user device, or user equipment (UE), etc. A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, a tablet, a smart book, a netbook, or other processing devices connected to a wireless modem, etc. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE/LTE-Advanced and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

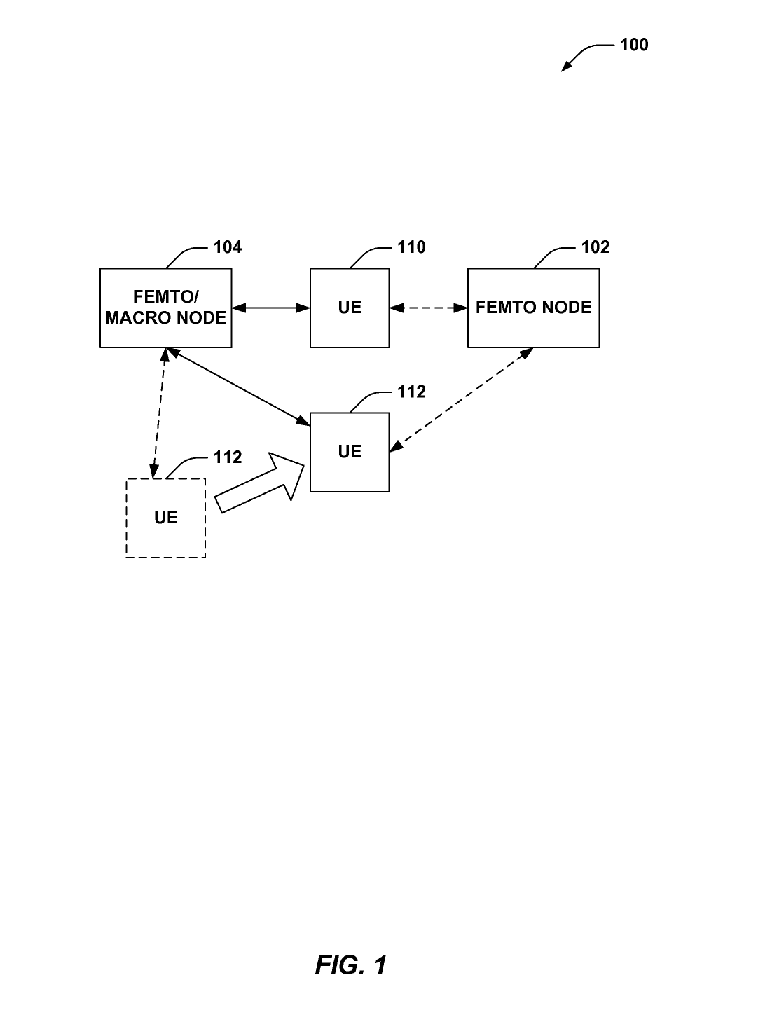

Referring to FIG. 1, a wireless communication system 100 is illustrated that facilitates classifying UEs near to a femto node for managing interference caused thereto. System 100 can include a femto node 102 that can provide one or more UEs with wireless network access. For example, femto node 102 can implement restricted association such to allow access to a group of UEs while denying access, or providing a lower level of access, to other UEs. System 100 also includes a femto/macro node 104 to which UEs 110 and 112 communicate to receive wireless network access. In one example, femto node 102, as described, can be substantially any low power base station, such as a H(e)NB, pico node, micro node, etc. Femto/macro node 104 can be substantially any base station, such as a mobile base station, relay, etc., a UE (e.g., communicating in peer-to-peer or ad-hoc mode with UEs 110 and 112), a portion thereof, and/or any device that can provide wireless network access to UEs 110 and 112. Moreover, UEs 110 and 112 can be mobile terminals, stationary devices, modems (or other tethered devices), a portion thereof, and/or substantially any device that wirelessly communicates with femto/macro node 104.

According to an example, UEs 110 and 112 can communicate with femto/macro node 104. UE 112 can move from one position to another, as shown, over a short period of time, and can continue to move about the wireless network. UE 110 can be more stationary, communicating with femto/macro node 104 for a longer period of time. Femto node 102, as described, can implement restricted association such that UEs 110 and 112 are not allowed to communicate with femto node 102. In one example, femto node 102 can operate a closed subscriber group (CSG), of which UEs 110 and 112 are not members. In this regard, since UEs 110 and 112 cannot handover to the femto node 102 when within a range thereof, the femto node 102 can cause interference to UEs 110 and 112 depending on its proximity to the UEs 110 and 112.

Since UE 112 moves throughout the network, however, interference caused thereto may not be as detrimental as interference to UE 110, which remains substantially stationary for a period of time. In one specific example, femto/macro node 104 can be a femto node in a home/office of a user that also uses UE 110. Thus, UE 110 can communicate with femto/macro node 104 for a substantial portion of the day, and can thus be interfered by femto node 102, which can be near to femto/macro node 104, for the substantial portion of the day. Conversely, UE 112 can move in and out of proximity of femto node 102 and/or femto/macro node 104, and thus is not subject to the constant interference from femto node 102 as UE 110. Thus, for mitigating interference to UEs 110 and 112, femto node 102 can classify the UEs 110 and 112 to more effectively mitigate interference caused thereto (e.g., when receiving interference reports regarding the UEs 110 and 112 from femto/macro node 104, and/or the like).

In an example, femto node 102 can periodically cause UEs to attempt registration with femto node 102. For instance, femto node 102 can temporarily modify an advertised location area code (LAC) or other information broadcast by femto node 102 for a short duration of time. The UEs 110 and 112 can detect the LAC and determine to attempt handover or reselection to femto node 102. Femto node 102 can receive the registration request and determine one or more identifiers of the UEs 110 and 112. Once the time duration for using the modified LAC expires, the femto node 102 can return to broadcast its previous LAC. In one example, femto node 102 modifies the LAC a number of times (e.g., according to a regular periodic time interval or random interval, based on one or more events, etc.) over a period of time and tracks the UEs that attempt registration following the modification. In this example, where UE 110 remains within proximity of femto node 102, UE 110 can attempt registration at many of the LAC modifications, whereas UE 112 moving throughout the wireless network may not attempt more than one registration with femto node 102, and the registration may be upon entering a coverage area thereof and not necessarily during the LAC modification. Tracking registrations based on modifying a LAC, in this example, femto node 102 can respectively classify UEs 110 and 112 as neighboring and passer-by (or non-neighboring).

In another example, femto node 102 can monitor registration times of UEs 110 and 112 respective to one another and/or an expiration timer value for reattempting registration to femto node 102. For example, the UEs 110 and 112 can place femto node 102 (or related LAC) in a forbidden list of accessible base stations for the timer value duration upon initially determining an inability to establish a connection to the femto node 102. When the timer expires, UEs 110 and 112 can reattempt registration with femto node 102. In this regard, femto node 102 can evaluate timing of the registration attempts of UE 110 and 112. Where the intervals between registration attempts closely correspond to one another, this can indicate a clustering around a forbidden list timer value. Thus, femto node 102 can determine UE 110 is a neighboring UE based on clustering of the registration attempts around similar values, and determine UE 112 is a passer-by based on detecting no such clustering of registration attempts around the timer value. In another example, where the forbidden list timer value is known, the intervals can be compared to the forbidden list timer value to determine whether the registration attempts occur once the timer expires, which can indicate the UE is neighboring femto node 102 at the end of each timer expiration.

In another example, UEs 110 and 112 can report a signal strength measurement of femto node 102 at the UE (e.g., as similarly reported in a measurement report for cell reselection) as part of attempting registration. Femto node 102 can receive the signal strength measurements and can classify UEs 110 and 112 based on a plurality of signal strength measurements over time. For example, signal strength of femto node 102 at a neighboring UE, such as UE 110, can be higher over one or more measurements than that reported by UE 112, which can be similar to qualities at the cell edge of femto node 102 due to UE 112 passing by. Thus, based on these measurements, femto node 102 can classify UEs 110 and 112 and neighboring and/or non-neighboring.

Moreover, once femto node 102 has classified UEs 110 and 112 as neighbor, passer-by, or some status in between, femto node 102 can calibrate its downlink transmit power to mitigate interference to neighbor UEs. For example, femto node 102 can set its transmit power to yield under a threshold number of UE registrations. In another example, femto node 102 can set transmit power so a weighted sum of registrations from neighbor UEs and passer-by UEs are below a threshold. In yet another example, femto node 102 can grant limited or full access to neighbor UEs. In any case, allowing such classification of UEs can permit the femto node 102 to more effectively handle interference caused to the UEs. It is to be appreciated that though modification of LAC is described above, the concepts can similarly be applied for other advertised paging area identifiers, such as RAC, TAC, and/or the like.

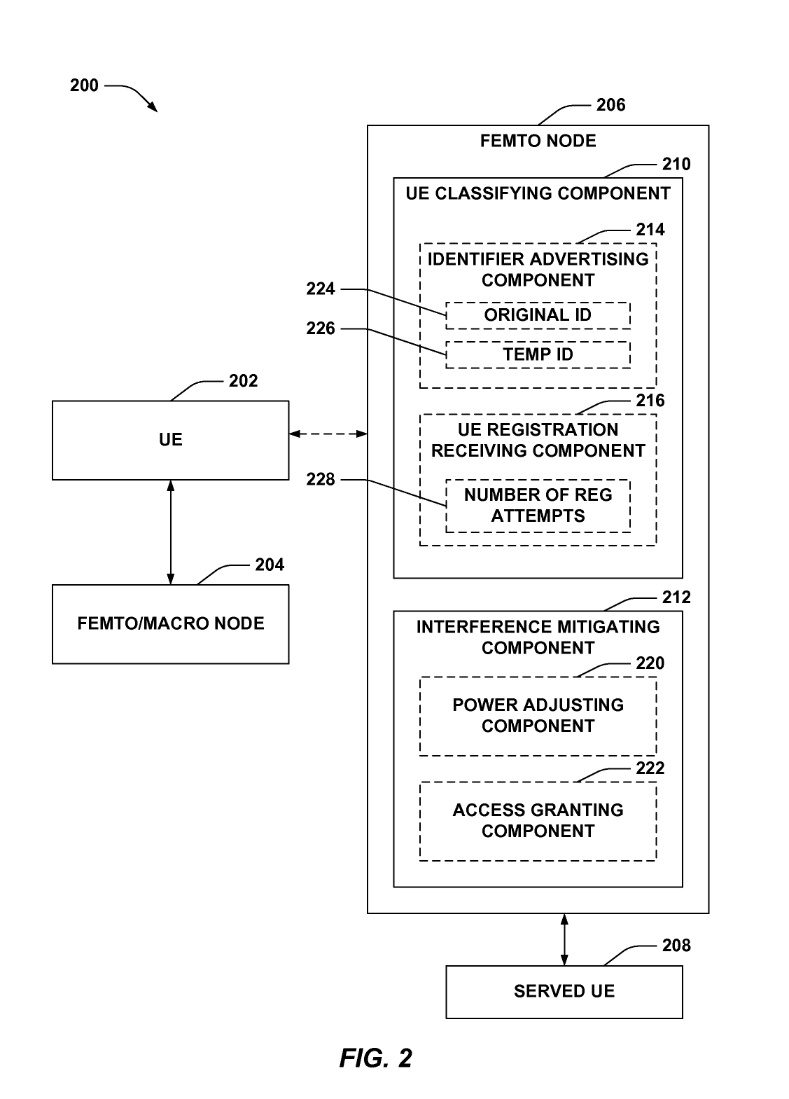

Turning now to FIG. 2, an example wireless communication system 200 is illustrated that facilitates classifying a UE. System 200 comprises a UE 202 that communicates with a femto/macro node 204 to receive access to a wireless network. In addition, system 200 can include a femto node 206 that can similarly advertise wireless network access to one or more UEs, such as served UE 208. Femto/macro node 204 can be a macro node, pico node, femto node, mobile base station, a UE (e.g., communicating in peer-to-peer or ad-hoc mode with UEs 202/208), a portion thereof, etc. As described, femto node 206 can be a low power base station, such as a H(e)NB, etc., in a home of a user, an office, and/or the like. UEs 202 and 208 can be mobile terminals, stationary devices, modems (or other tethered devices), a portion thereof, and/or substantially any device that wirelessly communicates with femto/macro nodes.

Femto node 206 can include a UE classifying component 210 for determining whether a UE is a passer-by UE, a neighboring UE that communicates with a neighboring base station for an extended period of time, and/or varying levels in between, and an interference mitigating component 212 for attempting to mitigate interference to the UE based on its classification. UE classifying component 210 can optionally include an identifier advertising component 214 for modifying a broadcasted paging identifier (such as LAC, TAC, RAC, etc.), and/or a UE registration receiving component 216 for obtaining and/or processing registration requests from one or more UEs. Interference mitigating component 212 can optionally include a power adjusting component 220 for modifying a transmission power of the femto node 206 based at least in part on a UE classification, and/or an access granting component 222 for allowing the one or more UEs to access femto node 206.

According to an example, UE classifying component 210 can detect presence of UE 202 and can determine whether UE 202 is a neighboring UE that is near femto node 206 for at least a threshold period of time, or is merely passing by femto node 206. UE classifying component 210 can determine such based on one or more inferences regarding other detected parameters, as described above and further herein. Based at least in part on this determination, for example, interference mitigating component 212 can determine whether and/or how to mitigate interference to the UE 202. For example, interference mitigating component 212 can adjust a transmit power of femto node 206, allow UE 202 to communicate with femto node 206 where the UE 202 is not a member of a related CSG, etc.

In one example, UE classifying component 210 can classify UE 202 based on modifying a paging area identifier broadcast by femto node 206. For example, identifier advertising component 214 can advertise an original identifier 224 value for femto node 206 related to a paging area for femto node 206 (e.g., a LAC, RAC, TAC, etc.). Using such identifiers allows femto nodes to associate in a group of nodes using the same identifier such that UEs moving between the femto nodes need not register with femto nodes that advertise the same identifier, which conserves signaling over the wireless network. Advertising the identifier 224 can include broadcasting the identifier 224 in a master information block (MIB), system information block (SIB), etc., in LTE, or other system information broadcast message. UE 202 can maintain a list of identifiers related to nodes which UE 202 cannot access (e.g., because related cells associate with a CSG of which UE 202 is not a member) to prevent repeated registration attempts with nodes advertising an identifier in the list. In an example, however, the UE 202 can periodically flush the list of identifiers (e.g., substantially all identifiers can be deleted from the list) after a period of time (e.g., every day, after a number of hours, etc.), so that UE 202 can occasionally reattempt to access the nodes. This can be performed according to a timer, referred to herein as the forbidden list timer. In another example, UE 202 can remove individual identifiers according to associated separate timers, which can also be referred to as forbidden list timers.

To classify UE 202, for example, identifier advertising component 214 can advertise a temporary identifier 226 (e.g., LAC, RAC, TAC, etc.) during a period of time, which may cause UE 202 to attempt registration with femto node 206. The UE 202, upon encountering the temporary identifier 226, can attempt registration with femto node 206. For example, this can include UE 202 performing an idle mode reselection or active mode hand-in procedure to the femto node 206 based on the temporary identifier 226 and a measured signal strength of the femto node 206, initiating an radio resource control (RRC) connection with the femto node 206, sending a registration message, such as a location area update, to the femto node 206, and/or the like. In this example, UE registration receiving component 216 can obtain the registration request from UE 202 and can identify the UE 202 based on one or more identifiers in the registration attempt (e.g., an international mobile subscriber identity (IMSI), temporary mobile subscriber identity (TMSI), etc.

Identifier advertising component 214 can continue advertising the original identifier 224 after a period of time, where the period of time can be such to allow all UEs within proximity to attempt registration to femto node 206. For example, the period of time in LTE can around 365 seconds, which can correspond to an interval between measuring neighboring nodes at UE 202 and/or other UEs. Moreover, for example, when advertising the temporary identifier 226, UE registration receiving component 216 can release the UE 202 (via, for example, a RRC connection release message), but can specify a cause of the release such that the UE 202 does not place the temporary identifier 226 in the list of identifiers which UE 202 cannot access (e.g., a congestion cause for release). In addition, causing the release at the UE 202 can ensure UE 202 also does not store the temporary identifier 226 as a valid identifier. In any case, UE registration receiving component 216 can prevent UEs from registering with femto node 206 using the temporary identifier 226.

Subsequently, at another time, identifier advertising component 214 can again advertise the temporary identifier 226 for the period of time. For example, the times at which identifier advertising component 214 advertises the temporary identifier 226 can be periodic (e.g., every six hours, every 24 hours, etc.), non-periodic (e.g., based on a random time interval, based on one or more events such as detecting or otherwise receiving an indication of interference to one or more UEs over a threshold, based on an event specified by the UE 202 or users thereof, etc.). If UE 202 is still within a vicinity of femto node 206, UE 202 can again attempt registration based on the temporary identifier 226 (e.g., since the release cause was such to prevent UE 202 from adding the temporary identifier to the forbidden list, as described). Again, UE registration receiving component 216 can receive the registration attempt from UE 202 and identify the UE 202 based on IMSI, TMSI, etc. In this example, UE classifying component 210 can determine and store a number of registration attempts 228 received from UE 202 over a number of advertisements of the temporary identifier 226. Where the number of registration attempts 228 is at or above a threshold for the number of advertisements, UE classifying component 210 can determine UE 202 is a neighboring UE and/or not a passer-by UE. For example, UE classifying component 210 can determine a number of registration attempts 228 for given UEs, such as UE 202, over a number of days to determine whether the number of registration attempts 228 achieves a threshold. In any case, interference mitigating component 212 can mitigate interference to the UE 202, as described, based on the classification.

In another example, UE classifying component 210 can determine certain trends in receiving registration requests from UE 202. For example, UE classifying component 210 can detect that UE 202 performs registration based on the temporary identifier 226 at certain times of day, week, month, etc. as opposed to other times of the day, week, month, etc., and can determine the number of registration attempts 228 during these times for a more granular classification. For example, the UE 202 may be a neighboring UE during certain times of the day, while moving away from femto node 206 during other times (e.g., moving away around daytime during the week). Thus, in this example, interference mitigating component 212 can mitigate interference during the times of day when UE 202 is determined to be neighboring the femto node 206 according to detected trends, while maintaining a configured transmit power during other times.

For example, where UE classifying component 210 determines UE 202 is a neighboring UE, interference mitigating component 212 can attempt to lessen interference thereto. For example, power adjusting component 220 can maintain or lower a transmission power of femto node 206 to not interfere with UE 202 communications. Where UE classifying component 210 determines UE 202 is passing by (e.g., and thus may not be subject to interference from femto node 206 for an extended period of time), power adjusting component 220 can maintain transmission power, increase transmission power, or otherwise modify the transmission power by an amount different from where UE classifying component 210 determines UE 202 is a neighboring UE.

In one example, power adjusting component 220 can modify a transmission power of femto node 206 such that a total number of neighbor UEs that attempt registration with femto node 206 is below a threshold. For example, interference mitigating component 212 can determine a IMSI, TMSI, or other identifier in the registration attempts for determining whether the attempt is from a neighboring or non-neighboring UE. In another example, power adjusting component 220 can modify a transmission power so according to a specified weighted sum of neighbor UEs to passer-by UEs. Moreover, in an example, once UE classifying component 210 classifies the UE 202 as a neighbor UE, power adjusting component 220 can modify transmission power of femto node 206 when UE registration receiving component 216 obtains a registration request from UE 202.

In yet another example, access granting component 222 can modify a level of access provided to UE 202, which can include granting limited or full access to UE 202 accessing femto node 206, based at least in part on UE classifying component 210 determining that UE 202 is a neighbor UE. This can include identifying the UE 202 based on a IMSI, TMSI, or other identifier in an access request, and granting the request based on identifying the UE 202 as a neighboring UE. For example, though femto node 206 can operate in a CSG of which UE 202 is not a member, access granting component 222 can at least provide hybrid access to UE 202.

It is to be appreciated that served UE 208, which is served by femto node 206, may be impacted by the switching to the temporary identifier 226. To mitigate the impact, identifier advertising component 214 can refrain from paging served UE 208 regarding the switching to identifier 226. Moreover, where femto node 206 receives a location update request from served UE 208 based on served UE 208 detecting the switch to identifier 226, identifier advertising component 214 can switch back to original identifier 224 and can accordingly release the connection requested for the temporary identifier 226. Similarly, where femto node 206 receives a page for served UE 208 (e.g., a page from the core network related to a call for UE 208), identifier advertising component 214 can switch to the original identifier 224 before paging served UE 208.

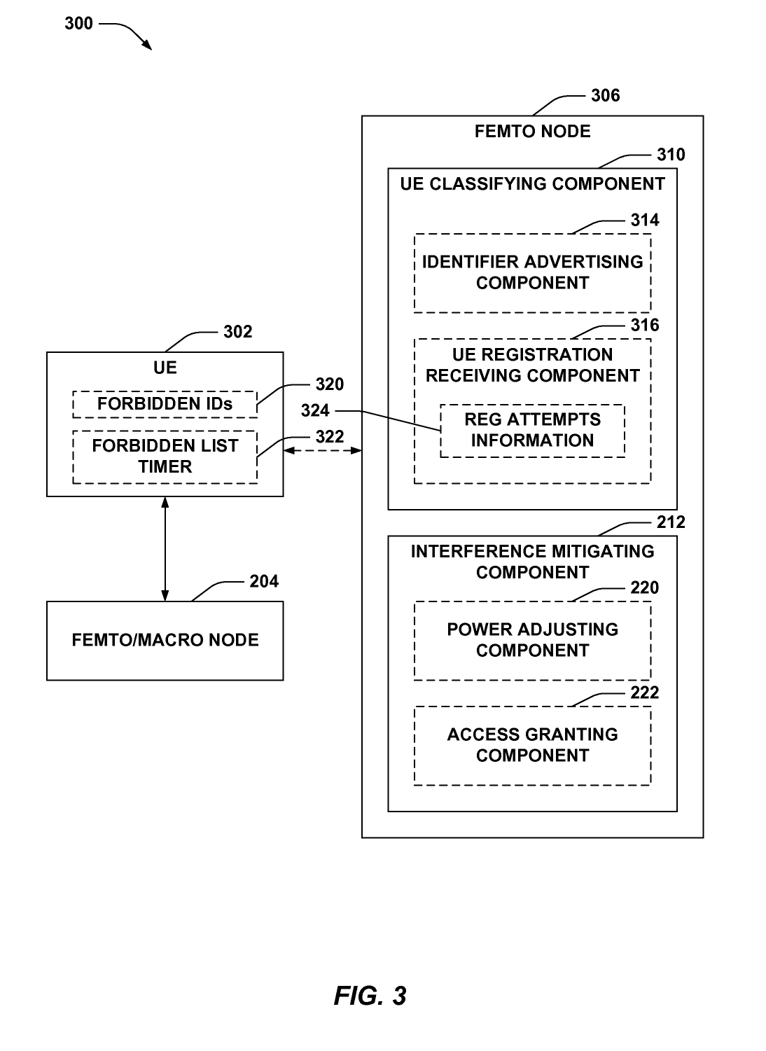

Referring to FIG. 3, an example wireless communication system 300 is illustrated that facilitates classifying a UE. System 300 comprises a UE 302 that communicates with a femto/macro node 204 to receive access to a wireless network. In addition, system 300 can include a femto node 306 that can similarly advertise wireless network access to one or more UEs. Femto/macro node 204 can be a macro node, pico node, femto node, mobile base station, a UE (e.g., communicating in peer-to-peer or ad-hoc mode with other UEs), a portion thereof, etc. As described, femto node 306 can be a low power base station, such as a H(e)NB, etc., in a home of a user, an office, and/or the like. UE 302 can be a mobile terminal, stationary device, modem (or other tethered device), a portion thereof, and/or substantially any device that wirelessly communicates with femto/macro nodes.

Femto node 306 can include a UE classifying component 310 for determining whether a UE is a passer-by UE, a neighboring UE that communicates with a neighboring base station for an extended period of time, and/or varying levels in between, and an interference mitigating component 212 for attempting to mitigate interference to the UE based on its classification. UE classifying component 310 can optionally include an identifier advertising component 314 for advertising an identifier, and/or a UE registration receiving component 316 for obtaining and/or processing registration requests from one or more UEs. Interference mitigating component 212 can optionally include a power adjusting component 220 for modifying a transmission power of the femto node 306 based at least in part on a UE classification, and/or an access granting component 222 for allowing the one or more UEs to access femto node 306.

According to an example, identifier advertising component 314 can advertise the identifier (e.g., LAC, RAC, TAC, etc.), and UE classifying component 310 can determine whether UE 302 is a neighbor UE or passer-by based at least in part on a number of registration attempts by UE 302 over a period of time, and/or an interval between attempts. In one example, UE 302 can attempt registration to femto node 306. UE registration receiving component 316 can obtain the request and can deny access to UE 302, which can cause UE 302 to populate a list of forbidden identifiers 320 with the original identifier of femto node 306. The UE 302 can remove the identifier from the list of forbidden identifiers 320 based on expiration of a forbidden list timer 322, which can be initialized based on one or more events, such as adding the identifier to the list of forbidden identifiers 320. In another example, the timer 322 is initialized upon UE 302 powering up, upon encountering a first identifier, etc., and can run until expiration and/or until another forbidden identifier is encountered. In another example, the UE 302 can utilize specific timers 322 for specific identifiers in the lost of forbidden identifiers 320.

In any case, after expiration of the timer 322, UE 302 can again attempt registration with femto node 206 where it remains a neighbor thereof. Thus, for example, UE registration receiving component 316 can store UE 302 registration attempts information 324 over a period of time, and UE classifying component 310 can classify the UE 302 as a neighboring UE or passing by based at least in part on the information 324. In an example, UE registration receiving component 316 can identify registration attempts of the UE 302 based on an IMSI, TMSI, or other identifier received in the registration requests, as described. For example, where the information 324 indicates multiple registration attempts over a period of time, UE classifying component 310 can determine the UE 302 is a neighboring UE.

In an additional or alternative example, UE registration receiving component 316 can analyze time intervals between registration attempts as stored in information 324. Where the information 324 indicates multiple registration attempts from UE 302 having intervals between the registrations that are similar to one another and/or similar to the timer value of forbidden list timer 322, UE classifying component 310 can determine the UE 302 is a neighboring UE. For example, similarity in the intervals between registration attempts can indicate the UE 302 attempts registration to femto node 306 at a substantially regular interval, which can be inferred as corresponding to a timer such as the forbidden list timer 322. Such behavior can be indicative of a neighboring UE since the UE registers at the regular interval as opposed to varying intervals (which can indicate the UE is registering when entering coverage area of the femto node 102).

Where the forbidden list timer 322 value is known at femto node 306, UE classifying component 310 can compare the one or more time intervals to the forbidden list timer 322 value to determine whether the one or more time intervals are within a threshold difference of the forbidden list timer 322 value. If so, this can similarly indicate that the UE 302 is constantly neighboring femto node 306, and thus UE classifying component 310 can classify UE 302 as a neighboring UE.

In a specific example, UE registration receiving component 316 can compare the average interval between a specific number of registrations and compare to a threshold difference from forbidden list timer 322 value. If the average interval is within the threshold difference, UE classifying component 310 can determine the UE 302 is a neighboring UE. If not (and/or based on the variance from the threshold difference), UE classifying component 310 can determine UE 302 is a passer-by UE (or some other classification in between). In another example, UE registration receiving component 316 can create a histogram of the time intervals between registrations of UE 302 relative to the forbidden list timer 322 value. UE classifying component 310 can determine whether UE is a neighboring UE based on whether a threshold number or portion of the time intervals are within a threshold time of the forbidden list timer 322 value.

Moreover, as described, it is to be appreciated that UE registration receiving component 316 can determine certain times of day, days of week, etc., where UE 302 neighbors femto node 306 based on the registration attempts information 324. For example, where the registration attempts information 324 indicates that UE 302 attempts registration with femto node 306 in the evening during the week and/or at various times on the weekend, UE classifying component 310 can classify UE 302 as a neighboring UE during off-peak hours (e.g., in the evening during the week, on weekends, holidays, etc.) while classifying the UE 302 as passer-by during peak or business hours.

As described, interference mitigating component 212 can attempt to lessen interference to UEs classified as neighboring UEs based on adjusting a power of femto node 306, allowing access to one or more neighboring UEs, etc. This can be different for different times of day where UEs are classified differently based on time of day, as described above.

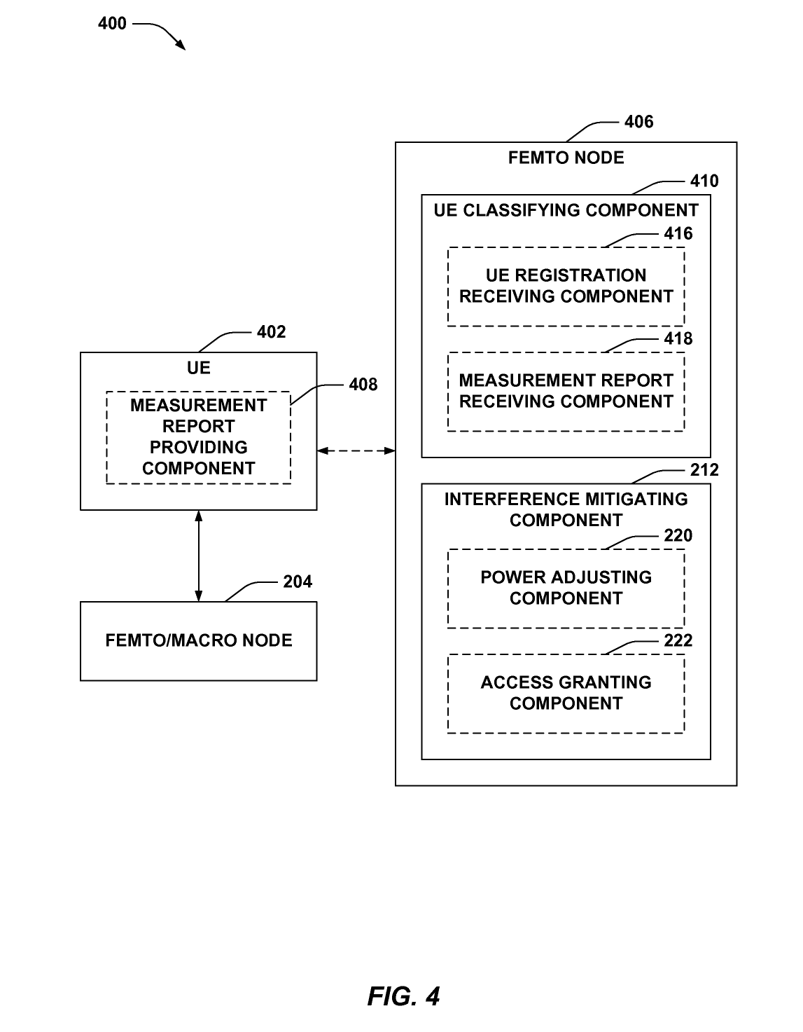

In FIG. 4, an example wireless communication system 400 is illustrated that facilitates classifying a UE. System 400 comprises a UE 402 that communicates with a femto/macro node 204 to receive access to a wireless network. In addition, system 400 can include a femto node 406 that can similarly advertise wireless network access to one or more UEs. Femto/macro node 204 can be a macro node, pico node, femto node, mobile base station, a UE (e.g., communicating in peer-to-peer or ad-hoc mode with other UEs), a portion thereof, etc. As described, femto node 406 can be a low power base station, such as a H(e)NB, etc., in a home of a user, an office, and/or the like. UE 402 can be a mobile terminal, stationary device, modem (or other tethered device), a portion thereof, and/or substantially any device that wirelessly communicates with femto/macro nodes.

UE 402 can include a measurement report providing component 408 for communicating measurement reports with a registration request for a femto node.

Femto node 406 can include a UE classifying component 410 for determining whether a UE is a passer-by UE, a neighboring UE that communicates with a neighboring base station for an extended period of time, and/or varying levels in between, and an interference mitigating component 212 for attempting to mitigate interference to the UE based on its classification. UE classifying component 410 can optionally include a UE registration receiving component 416 for obtaining and/or processing registration requests from one or more UEs, and/or a measurement report receiving component 418 for obtaining one or more measurement reports from a registration request of the one or more UEs. Interference mitigating component 212 can optionally include a power adjusting component 220 for modifying a transmission power of the femto node 406 based at least in part on a UE classification, and/or an access granting component 222 for allowing the one or more UEs to access femto node 406.

According to an example, measurement report providing component 408 can generate measurement reports for including in a registration request to femto node 406. In this example, femto node 406 can enable measurement reports on random access channel (RACH) or other radio resource registration requests. This allows the UE 402 to send the measurement reports or at least a measurement of a signal strength or quality of femto node 406 in a registration request thereto. For instance, femto node 406 can advertise the ability to receive such information in a registration request by broadcasting one or more parameters (e.g., in a system information block). In another example, femto node 406 can request the measurement report in response to a random access request from the UE 402. In this example, UE 402 can communicate the measurement report as part of a RRC connection request. In any case, the measurement reports can include measurement values of signal strength and/or quality (e.g., signal-to-noise ratio (SNR), total received power-to-interference ratio (Ecp/Io), reference signal code power (RSCP), etc.) measured of femto node 406 and/or other base stations at UE 402.

In this example, UE registration receiving component 416 can obtain a registration request from UE 402 (e.g., based on an original advertised identifier, such as LAC, RAC, TAC, etc., flushed from a list of forbidden identifiers, a different advertised identifier, etc.) including a measurement report. UE registration receiving component 416 can identify the UE 402 from the registration request based on a IMSI, TMSI, or other identifier in the request, Measurement report receiving component 418 can obtain the measurement report from the UE 402. UE classifying component 410, for example, can classify UE 402 based at least in part on measurement report. For example, where UE 402 reports a signal strength or quality from femto node 406 over a threshold, UE classifying component 410 can determine UE 402 is a neighbor UE.

In another example, UE classifying component 410 can determine whether UE 402 is a neighbor UE based at least in part on multiple measurement reports received from UE 402 over a period of time (e.g., one or more days, etc.). Thus, for example, where the measurement reports received from UE 402 over a given time period include femto node 406 and UE classifying component 410 determines a small change in measurements of signals from femto node 406 by UE 402, UE classifying component 410 can determine UE 402 is a neighboring UE. For example, each change in measurement of signals can be compared to a threshold to determine whether the change is smaller than the threshold. If so, the UE 402 is determined to be a neighboring UE. If at least one measurement, or an average of measurements, achieves the threshold, UE 402 can be determined to be a non-neighboring UE.

In yet another example, UE classifying component 410 can observe measurement reports received from UE 402 at measurement report receiving component 418 to determine whether signal measurements for femto node 406 are clustered around a value similar to that at a coverage boundary for femto node 406 (e.g., −12 decibel (dB)), referred to herein as a coverage boundary measurement. For example, if UE 402 is a passer-by, UE 402 can register with femto node 406 at a first opportunity (e.g., at a cell boundary of femto node), whereas if UE 402 is a neighboring UE, UE 402 can register with femto node 406 after expiration of a forbidden list timer, during which time UE 402 can be closer to femto node 406. Thus, where UE classifying component 410 determines that the measurement of signals from femto node 406 do not cluster around values seen at the coverage boundary of the femto node 406, UE classifying component 410 can determine UE 402 is a neighboring UE. Similarly in this example, UE classifying component 410 can create a histogram of the measurement values to determine whether the values on average are around measurements at the coverage boundary. In any case, neighbor UEs are characterized by continued presence in vicinity of the femto node 406.

As described, interference mitigating component 212 can attempt to lessen interference to UEs classified as neighboring UEs based on adjusting a power of femto node 406, allowing access to one or more neighboring UEs, etc. This can be different for different times of day where UEs are classified differently based on time of day, as described above.

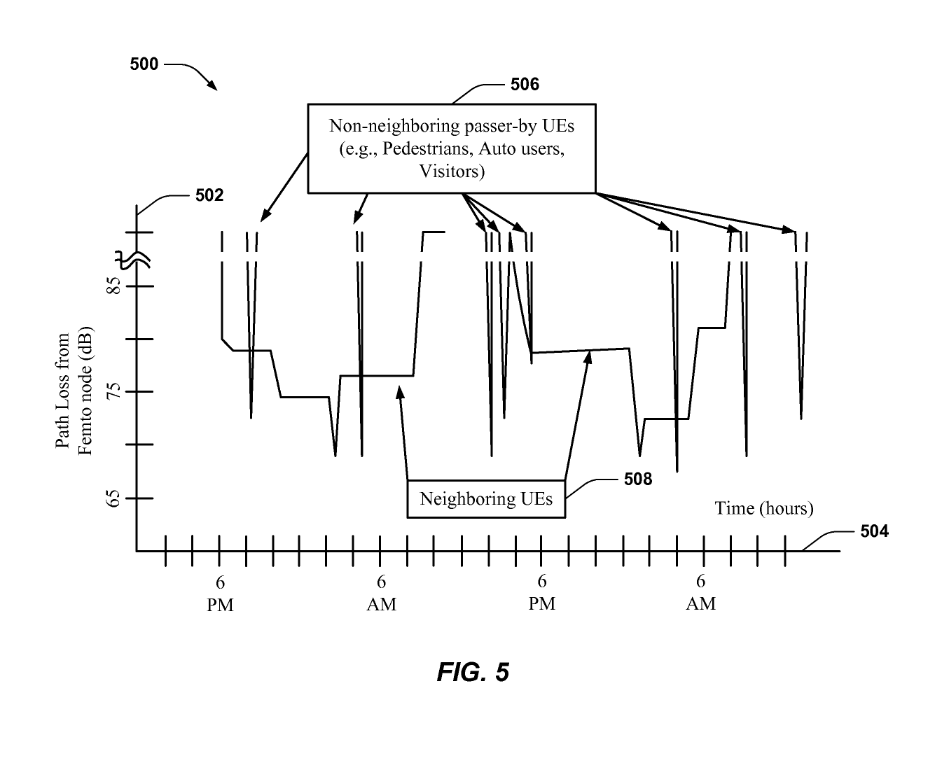

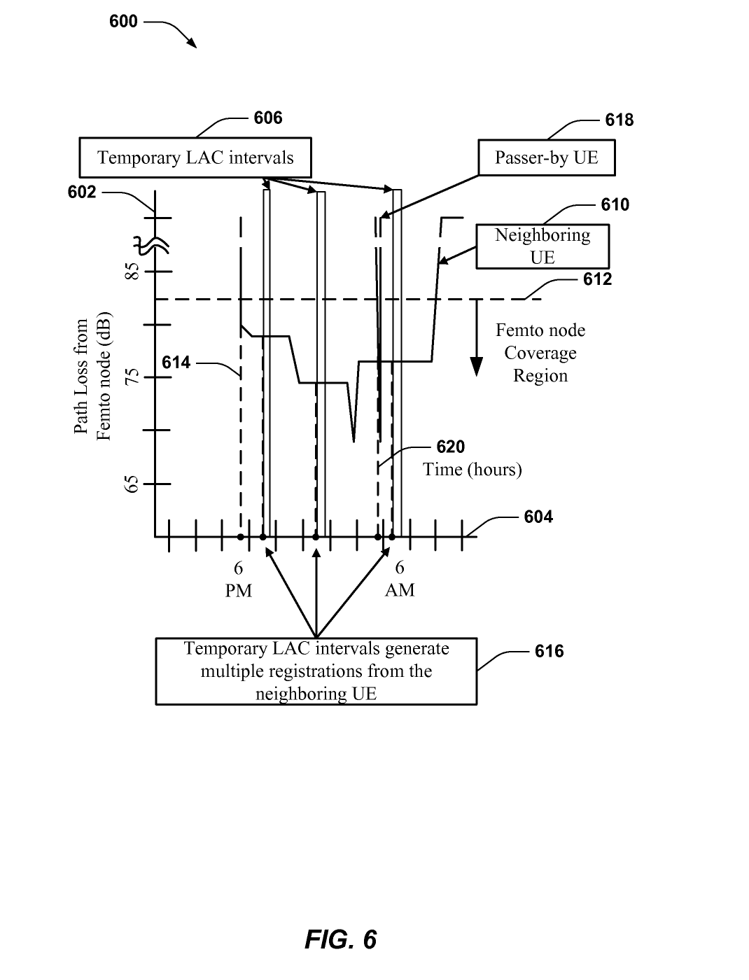

Turning to FIG. 5, an example graph 500 of pathloss of UEs to a femto node in decibels (dB), indicated at 502, over time, indicated at 504, is shown. One or more non-neighboring, or passer-by, UEs are indicated at 506. Such UEs, for example, can be on the person of a moving pedestrian or visitor at the site of the femto node, inside of an automobile passing the femto node, etc. Example pathlosses are shown at 506 as brief rapid decreases/increases in pathloss as the UEs move within and then out of range of the femto node. Similarly, example neighboring UE pathlosses are shown at 508 where the neighboring UEs are within coverage of the femto node for a longer period of time, having decreased pathloss for the period of time. Given these characteristics, the UEs can be classified as neighboring UEs or non-neighboring UEs, as described above and further herein. FIGS. 6-8 below further explain the examples for classifying UEs presented above with respect similar graphs.

Referring to FIG. 6, an example graph 600 of pathloss to a femto node in dB, indicated at 602, of one or more UEs over time, indicated at 604, is illustrated. In this graph 600, the femto node can switch to a temporary LAC, as described. For example, temporary LAC intervals 606 can occur around 8 pm, midnight, and 6 am for a few minutes of time (e.g., 365 seconds as described in previous examples), after which the femto node returns to advertising its original configured LAC. A pathloss representation of a neighboring UE 610 is shown where the neighboring UE 610 is within a femto node coverage region 612 for a period of about 14 hours.

Aside from registering when entering femto node coverage region 612, shown at 614, the neighboring UE 610 also registers during the temporary LAC intervals 606, shown at 614. Thus, based on receiving the multiple registrations, the femto node can classify the neighboring UE 610 as neighboring at least for a portion of the 14 hour period the UE is within the femto node coverage region 612. In addition, a passer-by UE 616 is shown, which registers upon entering the femto node coverage region 612, shown at 620. The passer-by UE 618, however, is not present during a temporary LAC intervals 606, and thus does not register during the temporary LAC intervals 606. Based on this, the femto node classifies the UE 618 as a passer-by UE.

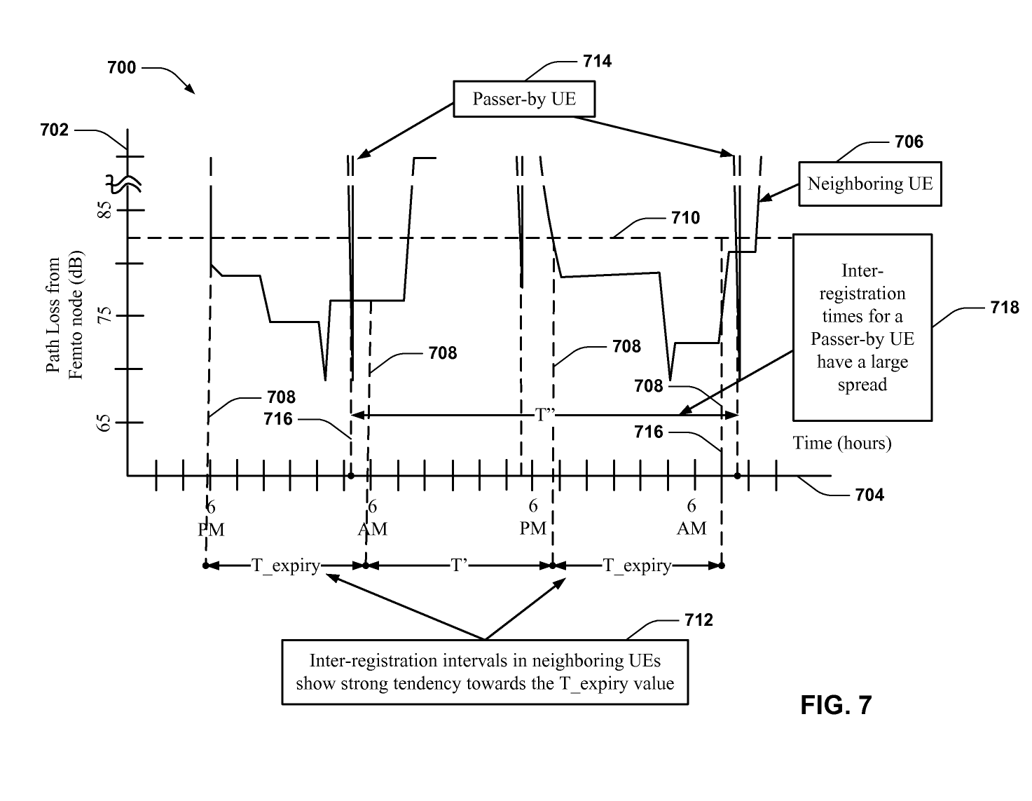

Turning to FIG. 7, an example graph 700 of pathloss to a femto node in dB, indicated at 702, of one or more UEs over time, indicated at 704, is illustrated. In this graph 700, the femto node can measure registration intervals of one or more UEs to determine a classification for the UEs. For example, a pathloss representation of a neighbor UE 706 is shown with various registration attempts 708 while within the femto node coverage region 710. The femto node can evaluate intervals between the registration attempts to classify the UE 706. Shown at 712 are two of the intervals that show a strong tendency toward one another and toward a T_expiry value that represents a timer for which the UE is forbidden from trying to access the femto node (or other nodes with a similar LAC) following receiving a rejection for a registration attempt (e.g., forbidden list timer).

The strong tendency shown at 712 can indicate the UE is near the femto node since the registration attempts likely occurred following expiration of the timer, and thus the femto node likely had the strongest signal of other nodes at the UE at expiration of the timer. Thus, the femto node classifies UE 706 as a neighboring UE. In addition, a passer-by UE 714 is shown that registers upon entering the femto node coverage region 710, shown at 716. The passer-by UE 714 has a large interval 718 between registrations 716. This can indicate that the passer-by UE 714 registers when moving near the femto node, but is not necessarily within coverage of the femto node when the timer forbidding access of the femto node expires. Thus, this UE 714 is not neighboring femto node, and is classified as a passer-by UE.

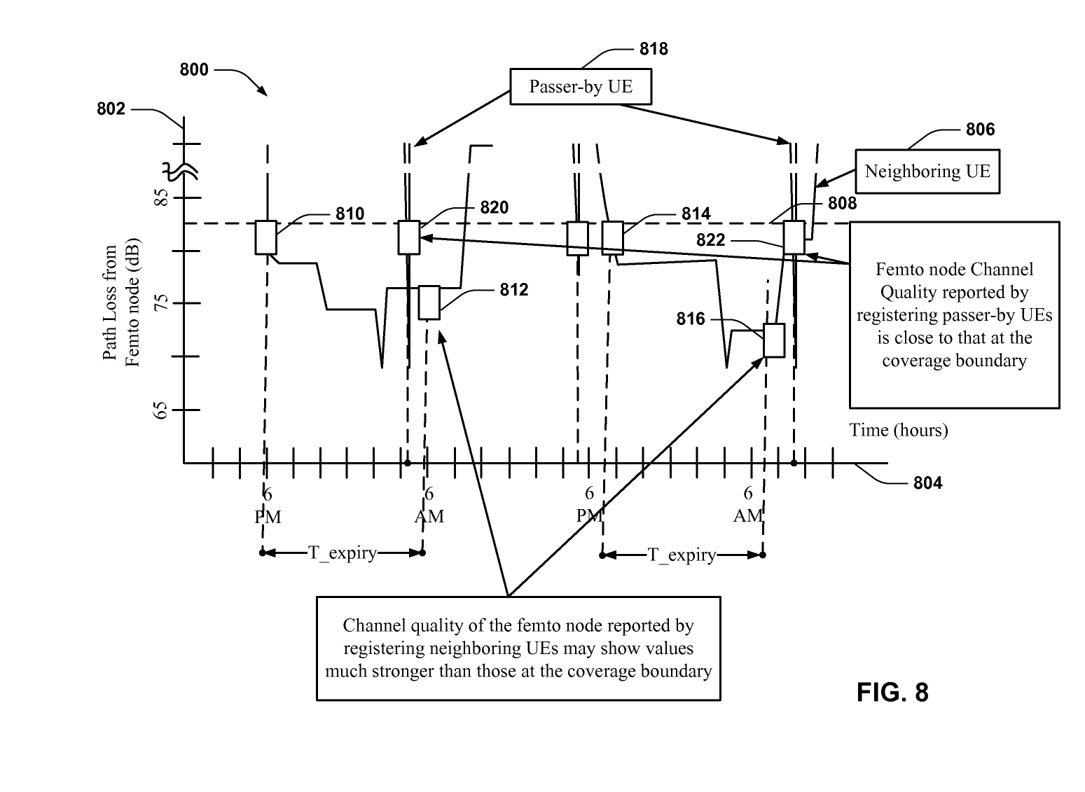

In FIG. 8, an example graph 800 of pathloss to a femto node in dB, indicated at 802, of one or more UEs over time, indicated at 804, is illustrated. In this graph 800, the UEs can communicate measurement reports to the femto node as part of a registration request. For example, a pathloss representation of a neighboring UE 806 is shown. The neighboring UE 806 attempts registration upon entering the femto node coverage region 808 at 810, where the registration 810 includes a measurement of the femto node (e.g., in a measurement report or otherwise). The neighboring UE 806 also registers with a measurement at 812, which can be following expiration of a timer forbidding registration requests to the femto node (or related LAC), as described (e.g., forbidden list timer). The neighboring UE 806 exits and reenters the femto node coverage region 808, and attempts registration at 814 with a measurement, and again at 816.

In this example, the femto node evaluates the measurement values at 810, 812, 814, and/or 816. The measurements received at 812 and 816 are different than one another and different than those received at 810 and 814. This can indicate the UE 806 is a neighboring UE, and the femto node can classify as such, at least since the different measurements indicate that the UE 806 was further within the coverage region 808 for at least some of the measurements, and thus close to the femto node for a period of time. A passer-by UE 818 is also shown that attempts registration and includes a measurement at 820 and 822. These measurements are similar as both are the result of the passer-by UE 818 entering the femto node coverage region 808 as opposed to staying within the femto node coverage region 808. Thus, the femto node can classify the UE 818 as a passer-by, as described.

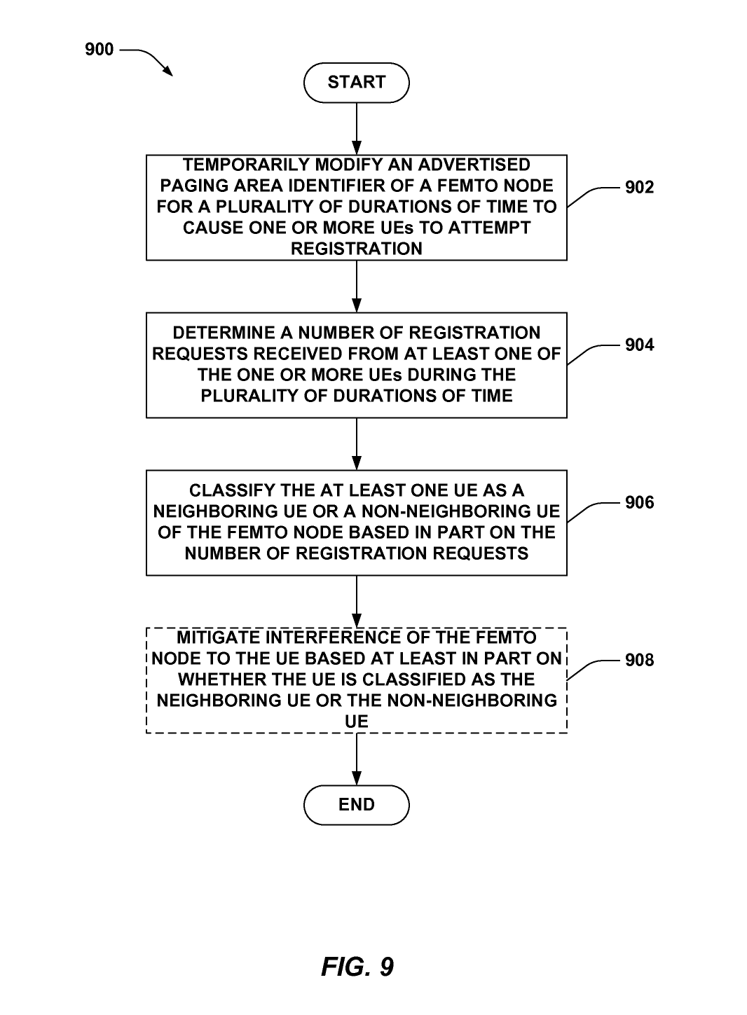

FIGS. 9-11 illustrate example methodologies relating to classifying UEs for mitigating interference thereto. While, for purposes of simplicity of explanation, the methodologies are shown and described as a series of acts, it is to be understood and appreciated that the methodologies are not limited by the order of acts, as some acts may, in accordance with one or more embodiments, occur concurrently with other acts and/or in different orders from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

FIG. 9 depicts an example methodology 900 for classifying one or more UEs for mitigating interference thereto.

At 902, an advertised paging area identifier of a femto node is temporarily modified for a plurality of durations of time to cause one or more UEs to attempt registration. For example, the paging area identifier can be a LAC, RAC, TAC, etc., as described. Modification can include using a temporary paging area identifier. Upon detecting the temporary paging area identifier, one or more UEs can request registration with the femto node, as described, though the one or more UEs may not have access to the femto node and may have forbade accessing based on the previous paging area identifier for a period of time. Moreover, the duration of time for modifying the paging area identifier can be small enough to mitigate impact to UEs served by the femto node, but large enough to allow UEs that may be communicating with other nodes to attempt registration to the femto node. In addition, following the duration of time (or based one or more events, such as receiving a page or location update request for a served UE), the femto node can return to advertising its original paging area identifier. Also, the modification can occur during a regular periodic time interval, a non-periodic interval (e.g., based on a random timer, one or more UE-specified or other detected events), and/or the like.

At 904, a number of registration requests received from at least one of the one or more UEs during the plurality of durations of time can be determined. For instance, the number of registration requests can indicate whether the UE is near the femto node during the paging area identifier switching. If so, this can be an indication that the UE frequently neighbors the femto node. In addition, the number of registrations can be determined for different specific time periods within one or more days, weeks, months, etc. Registration requests for the UE can be identified, as described, by a IMSI, TMSI, etc. in the request. When a registration request is received at the femto node, for example, the femto node can deny the request with a code that causes the UE to not put the paging area identifier in a forbidden list, such as a release message with a congestion cause. Thus, the UE, if still near the femto node, can respond to a subsequent paging area identifier switch with another registration request.

At 906, the at least one UE can be classified as a neighboring UE or a non-neighboring UE of the femto node based in part on the number of registration requests. For example, as described, the number of registration requests can be compared to a threshold to determine whether the UE is frequently neighboring the femto node. Moreover, as described, the number of registration requests can be compared for a certain time of day, week, month, etc., such that the UE can be classified as neighboring for a period of time and non-neighboring for another period of time (e.g., non-neighboring during business hours and neighboring outside of business hours).

Optionally, at 908, interference of the femto node to the UE can be mitigated based at least in part on whether the UE is classified as the neighboring UE or the non-neighboring UE. Mitigating interference can include lowering a transmit power, allowing access to the UE, and/or the like. Thus, in one example, the femto node can lower its transmit power upon detecting presence of the neighboring UE (e.g., based on receiving a registration attempt from the UE identified by an IMSI, TMSI, etc., in the attempt), during a time in which the neighboring UE is expected to be in the vicinity of the femto node, as described, and/or the like. In either case, the femto node determines how to mitigate interference based in part on whether a detected UE is neighboring or non-neighboring.

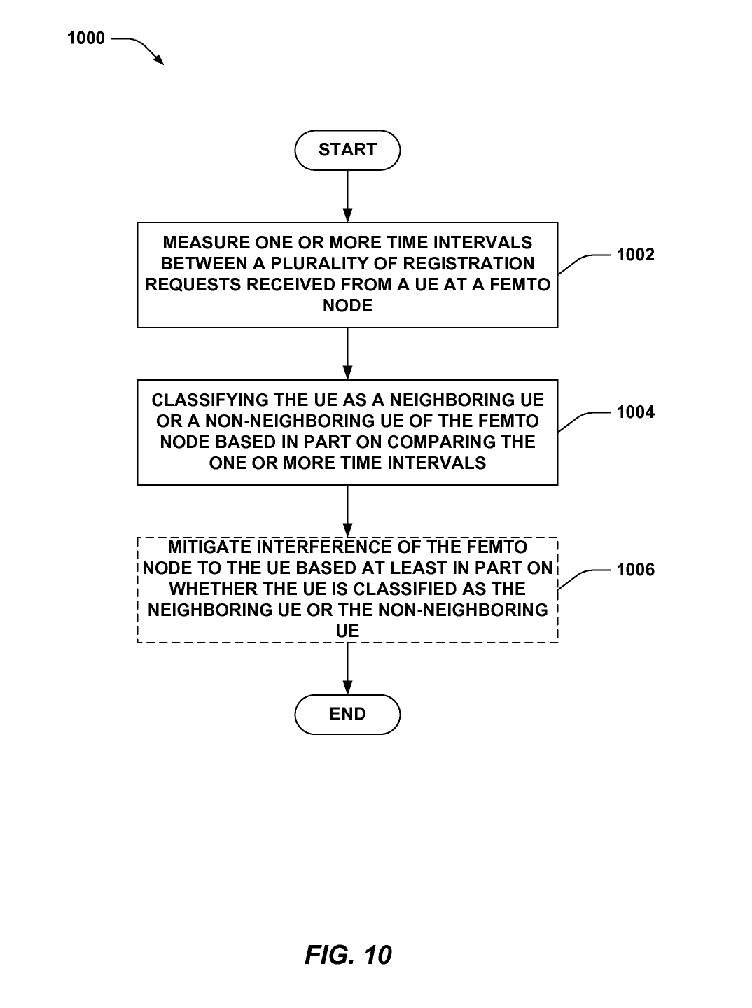

FIG. 10 illustrates an example methodology 1000 for classifying one or more UEs for mitigating interference thereto.

At 1002, one or more time intervals between a plurality of registration requests received from a UE at a femto node can be measured. This can include determining a difference in time of adjacent registration requests from the UE. Registration requests for the UE can be identified, as described, by an IMSI, TMSI, etc. in the request.

At 1004, the UE can be classified as a neighboring UE or a non-neighboring UE of the femto node based in part on comparing the one or more time intervals. For example, if the time intervals cluster around a similar value, this can indicate that the UE attempts registration when the femto node clears a forbidden list based on a forbidden list timer. It can be inferred from such behavior that the UE frequently neighbors the femto node, and thus is classified as a neighboring UE. Where the time intervals do not cluster, this can indicate the UE attempts registration at irregular intervals—likely when the UE moves within and outside of coverage of the femto node. It can be inferred from this behavior that the UE is not frequently neighboring the femto node, as described, and thus the UE can be classified as a non-neighboring (or passer-by) UE. In another example, where the forbidden list timer value is known, the time intervals can be compared to the forbidden list timer value to determine whether the intervals are at least within a threshold difference of the timer value. If so, this can indicate the UE frequently neighbors the femto node. In addition, the classifications can be specific to a time of day, week, month, etc., as described.

Optionally, at 1006, interference of the femto node to the UE can be mitigated based at least in part on whether the UE is classified as the neighboring UE or the non-neighboring UE. Mitigating interference can include lowering a transmit power, allowing access to the UE, and/or the like. Thus, in one example, the femto node can lower its transmit power upon detecting presence of the neighboring UE (e.g., based on receiving a registration attempt from the UE identified by an IMSI, TMSI, etc., in the attempt), during a time in which the neighboring UE is expected to be in the vicinity of the femto node, as described, and/or the like. In either case, the femto node determines how to mitigate interference based in part on whether a detected UE is neighboring or non-neighboring.

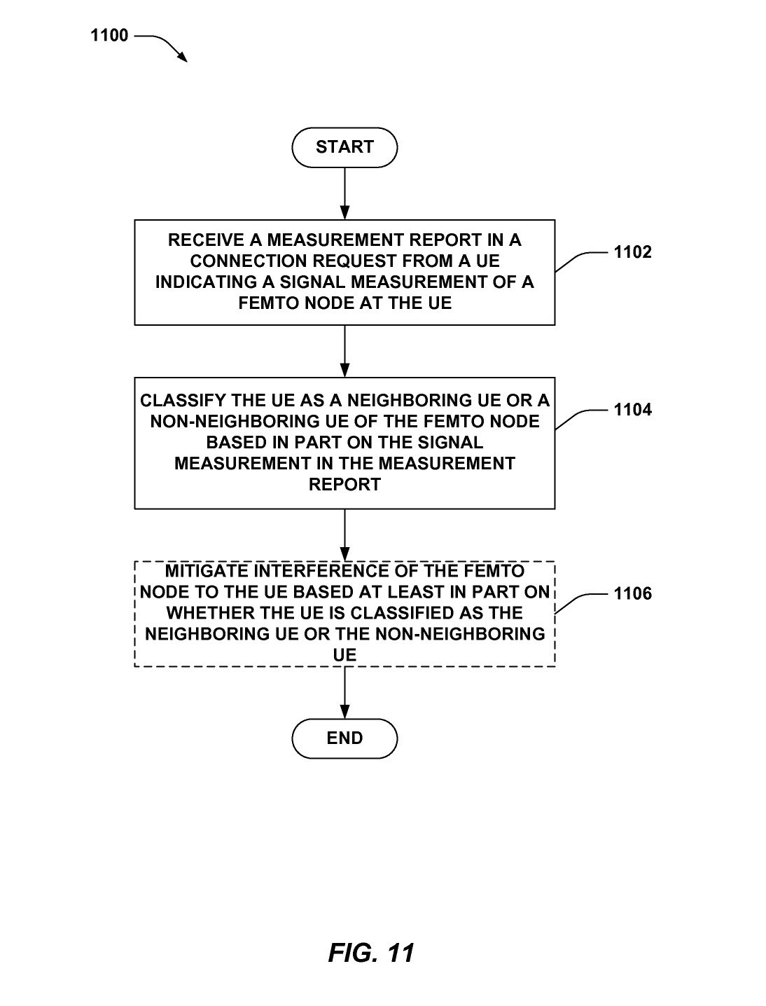

FIG. 11 illustrates an example methodology 1100 for classifying one or more UEs for mitigating interference thereto.

At 1102, a measurement report can be received in a connection request message from a UE indicating a signal measurement of a femto node at the UE. For instance, the signal measurement can indicate a signal strength or quality of a signal from the femto node at the UE. In one example, the measurement report can correlate to a measurement report sent to a serving base station in a handover procedure. Moreover, for example, the UE can communicate the measurement report as part of each connection request to the femto node.

At 1104, the UE can be classified as a neighboring UE or a non-neighboring UE of the femto node based in part on the signal measurement in the measurement report. For example, where the signal measurement is near that expected at a coverage boundary of the femto node, this can indicate an early measurement by a passer-by UE, whereas a stronger signal measurement can indicate a UE closer to the femto node when the measurement is performed. This can indicate the UE is neighboring since the measurement can be performed sometime after the UE enters the coverage area of the femto. In this regard, it is to be appreciated that multiple signal measurements can be considered, and where at least one measurements or an average of one or more measurements is not near the measurement expected at the coverage boundary, this can indicate the UE is neighboring the femto node for at least a period of time, and thus the UE is classified as a neighboring UE. In addition, the classifications can be specific to a time of day, week, month, etc., as described.

Optionally, at 1106, interference of the femto node to the UE can be mitigated based at least in part on whether the UE is classified as the neighboring UE or the non-neighboring UE. Mitigating interference can include lowering a transmit power, allowing access to the UE, and/or the like. Thus, in one example, the femto node can lower its transmit power upon detecting presence of the neighboring UE (e.g., based on receiving a registration attempt from the UE identified by an IMSI, TMSI, etc., in the attempt), during a time in which the neighboring UE is expected to be in the vicinity of the femto node, as described, and/or the like. In either case, the femto node determines how to mitigate interference based in part on whether a detected UE is neighboring or non-neighboring.

It will be appreciated that, in accordance with one or more aspects described herein, inferences can be made regarding classifying the UEs based on LAC switching, registration counting, measurement report analyzing, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

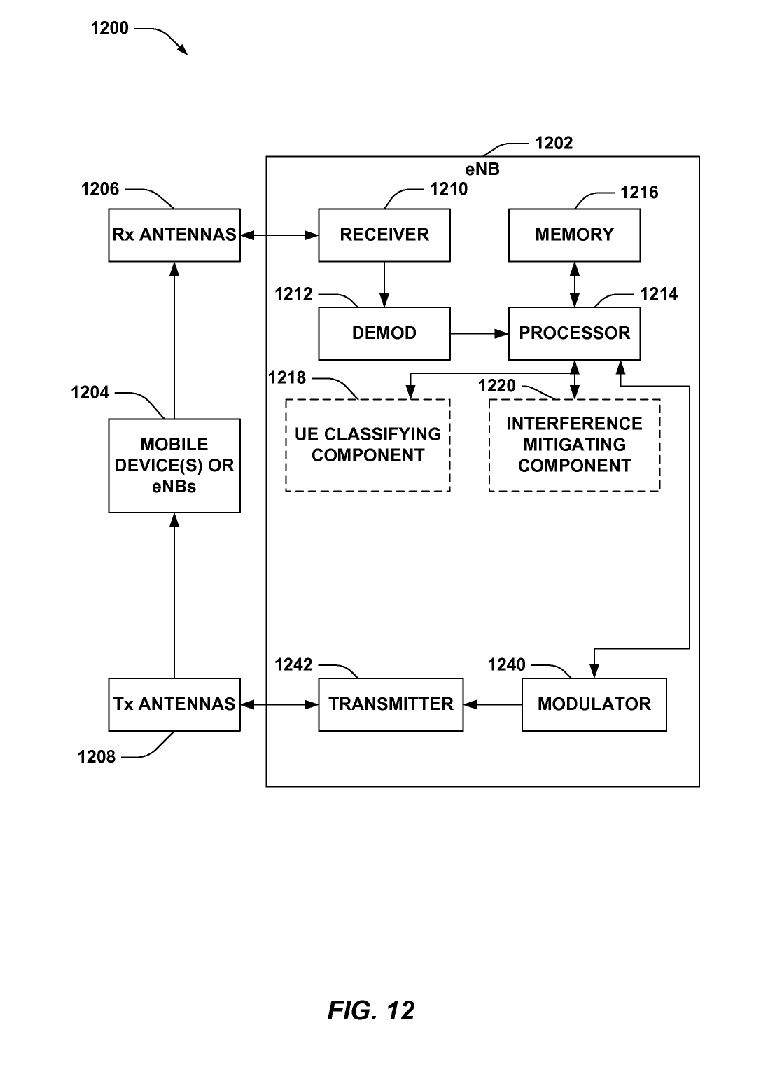

FIG. 12 is an illustration of a system 1200 that facilitates classifying UEs for mitigating interference thereto. System 1200 includes a eNB 1202 having a receiver 1210 that receives signal(s) from one or more mobile devices or eNBs 1204 through a plurality of receive antennas 1206 (e.g., which can be of multiple network technologies), and a transmitter 1242 that transmits to the one or more mobile devices or eNBs 1204 through a plurality of transmit antennas 1208 (e.g., which can be of multiple network technologies). For example, eNB 1202 can transmit signals received from eNBs 1204 to other eNBs 1204, and/or vice versa. Receiver 1210 can receive information from one or more receive antennas 1206 and is operatively associated with a demodulator 1212 that demodulates received information. In addition, in an example, receiver 1210 can receive from a wired backhaul link. Though depicted as separate antennas, it is to be appreciated that at least one of receive antennas 1206 and a corresponding one of transmit antennas 1208 can be combined as the same antenna. Demodulated symbols are analyzed by a processor 1214, which is coupled to a memory 1216 that stores information related to performing one or more aspects described herein.

Processor 1214, for example, can be a processor dedicated to analyzing information received by receiver 1210 and/or generating information for transmission by a transmitter 1242, a processor that controls one or more components of eNB 1202, and/or a processor that analyzes information received by receiver 1210, generates information for transmission by transmitter 1242, and controls one or more components of eNB 1202. In addition, processor 1214 can perform one or more functions described herein and/or can communicate with components for such a purpose.

Memory 1216, as described, is operatively coupled to processor 1214 and can store data to be transmitted, received data, information related to available channels, data associated with analyzed signal and/or interference strength, information related to an assigned channel, power, rate, or the like, and any other suitable information for estimating a channel and communicating via the channel. Memory 1216 can additionally store protocols and/or algorithms associated with classifying UEs for interference mitigation 1202.

It will be appreciated that the data store (e.g., memory 1216) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1216 of the subject systems and methods is intended to comprise, without being limited to, these and any other suitable types of memory.

Processor 1214 is further optionally coupled to a UE classifying component 1218, which can be similar to UE classifying component 210, 310, or 410, and/or an interference mitigating component 1220, which can be similar to interference mitigating component 212. Moreover, for example, processor 1214 can modulate signals to be transmitted using modulator 1240, and transmit modulated signals using transmitter 1242. Transmitter 1242 can transmit signals to mobile devices or eNBs 1204 over Tx antennas 1208. Furthermore, although depicted as being separate from the processor 1214, it is to be appreciated that the UE classifying component 1218, interference mitigating component 1220, demodulator 1212, and/or modulator 1240 can be part of the processor 1214 or multiple processors (not shown), and/or stored as instructions in memory 1216 for execution by processor 1214.

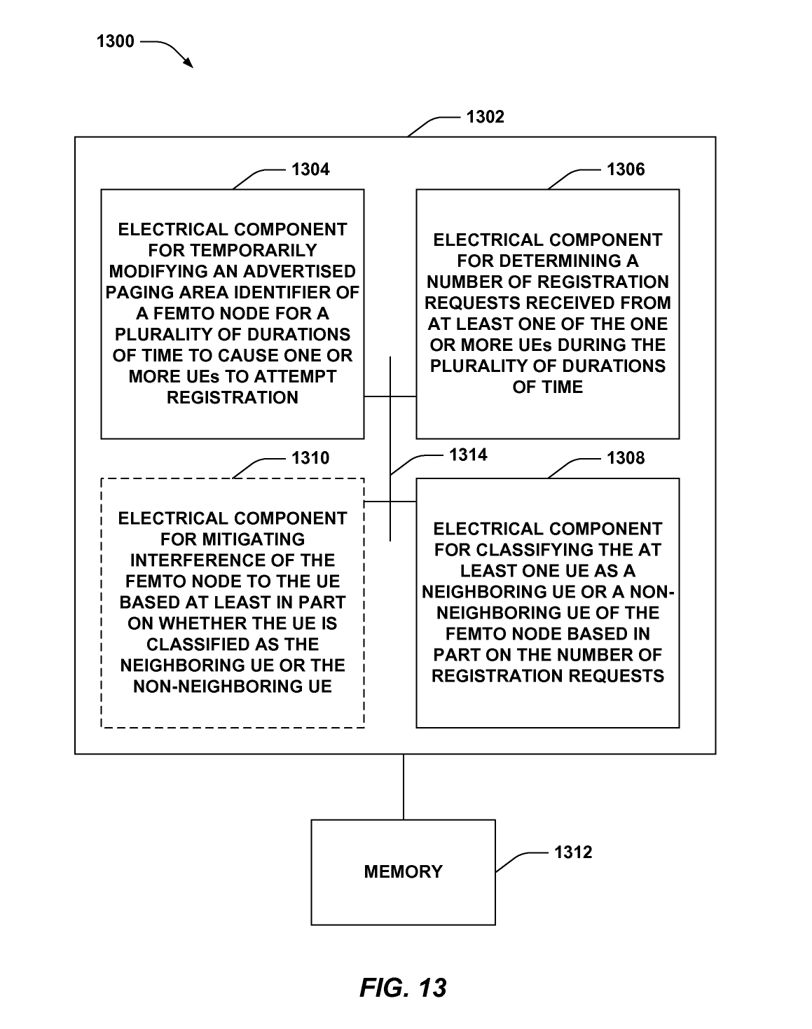

FIG. 13 illustrates a system 1300 for classifying UEs and mitigating interference thereto. For example, system 1300 can reside at least partially within a femto node or other low power base station. It is to be appreciated that system 1300 is represented as including functional blocks, which can be functional blocks that represent functions implemented by a processor, software, or combination thereof (e.g., firmware). System 1300 includes a logical grouping 1302 of electrical components that can act in conjunction. For instance, logical grouping 1302 can include an electrical component for temporarily modifying an advertised paging area identifier of a femto node for a plurality of durations of time to cause one or more UEs to attempt registration 1304. As described, this can include modifying to a temporary identifier and switching back to an original identifier following the duration of time. Further, logical grouping 1302 can include an electrical component for determining a number of registration requests received from at least one of the one or more UEs during the plurality of durations of time 1306.

Logical grouping 1302 also includes an electrical component for classifying the at least one UE as a neighboring UE or a non-neighboring UE of the femto node based in part on the number of registration requests 1308. As described, if the number of registration requests achieves a threshold, this can indicate the UE is a neighboring UE. Logical grouping 1302 can further include an optional electrical component for mitigating interference of the femto node to the UE based at least in part on whether the UE is classified as the neighboring UE or the non-neighboring UE 1310. As described, this can include reducing a transmit power, allowing access to neighboring UEs, etc.

For example, electrical component 1304 can include an identifier advertising component 214, as described above. In addition, for example, electrical component 1306, in an aspect, can include a UE registration receiving component 216, as described above. Electrical component 1308 can include a UE classifying component 210, and/or electrical component 1310 can include an interference mitigating component 212, as described.

Additionally, system 1300 can include a memory 1312 that retains instructions for executing functions associated with the electrical components 1304, 1306, 1308, and 1310. While shown as being external to memory 1312, it is to be understood that one or more of the electrical components 1304, 1306, 1308, and 1310 can exist within memory 1312. Moreover, for example, electrical components 1304, 1306, 1308, and 1310 can be interconnected by a bus 1314. In one example, electrical components 1304, 1306, 1308, and 1310 can include at least one processor, or each electrical component 1304, 1306, 1308, and 1310 can be a corresponding module of at least one processor. Moreover, in an additional or alternative example, electrical components 1304, 1306, 1308, and 1310 can be a computer program product comprising a computer readable medium, where each electrical component 1304, 1306, 1308, and 1310 can be corresponding code.

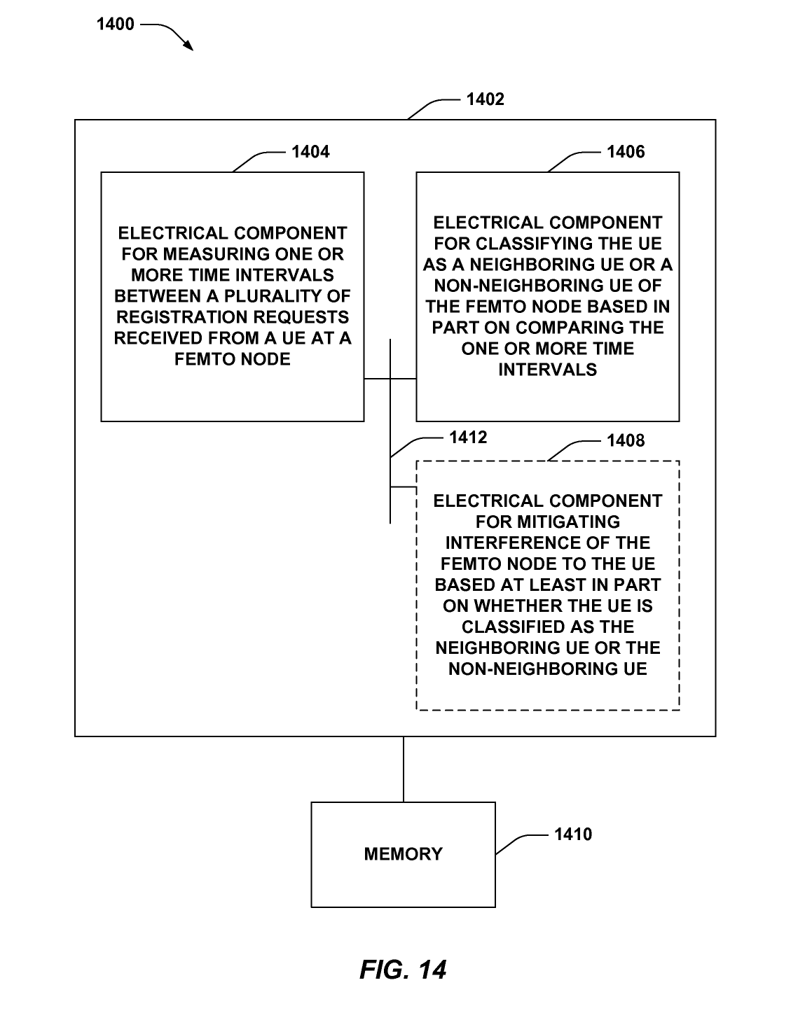

FIG. 14 illustrates a system 1400 for classifying UEs and mitigating interference thereto. For example, system 1400 can reside at least partially within a femto node or other low power base station. It is to be appreciated that system 1400 is represented as including functional blocks, which can be functional blocks that represent functions implemented by a processor, software, or combination thereof (e.g., firmware). System 1400 includes a logical grouping 1402 of electrical components that can act in conjunction. For instance, logical grouping 1402 can include an electrical component for measuring one or more time intervals between a plurality of registration requests received from a UE at a femto node 1404. Further, logical grouping 1402 can include an electrical component for classifying the at least one UE as a neighboring UE or a non-neighboring UE of the femto node based in part on comparing the one or more time intervals 1406.

As described, where the time intervals cluster around a value, which can be a forbidden timer value used by the UE, this can indicate the UE is a neighboring UE. Logical grouping 1402 can further optionally include an electrical component for mitigating interference of the femto node to the UE based at least in part on whether the UE is classified as the neighboring UE or the non-neighboring UE 1408. As described, this can include reducing a transmit power, allowing access to neighboring UEs, etc.

For example, electrical component 1404 can include UE registration receiving component 316, as described above. In addition, for example, electrical component 1406, in an aspect, can include a UE classifying component 310, and/or electrical component 1408 can include an interference mitigating component 212, as described.

Additionally, system 1400 can include a memory 1410 that retains instructions for executing functions associated with the electrical components 1404, 1406, and 1408. While shown as being external to memory 1410, it is to be understood that one or more of the electrical components 1404, 1406, and 1408 can exist within memory 1410. Moreover, for example, electrical components 1404, 1406, and 1408 can be interconnected by a bus 1412. In one example, electrical components 1404, 1406, and 1408 can include at least one processor, or each electrical component 1404, 1406, and 1408 can be a corresponding module of at least one processor. Moreover, in an additional or alternative example, electrical components 1404, 1406, and 1408 can be a computer program product comprising a computer readable medium, where each electrical component 1404, 1406, and 1408 can be corresponding code.

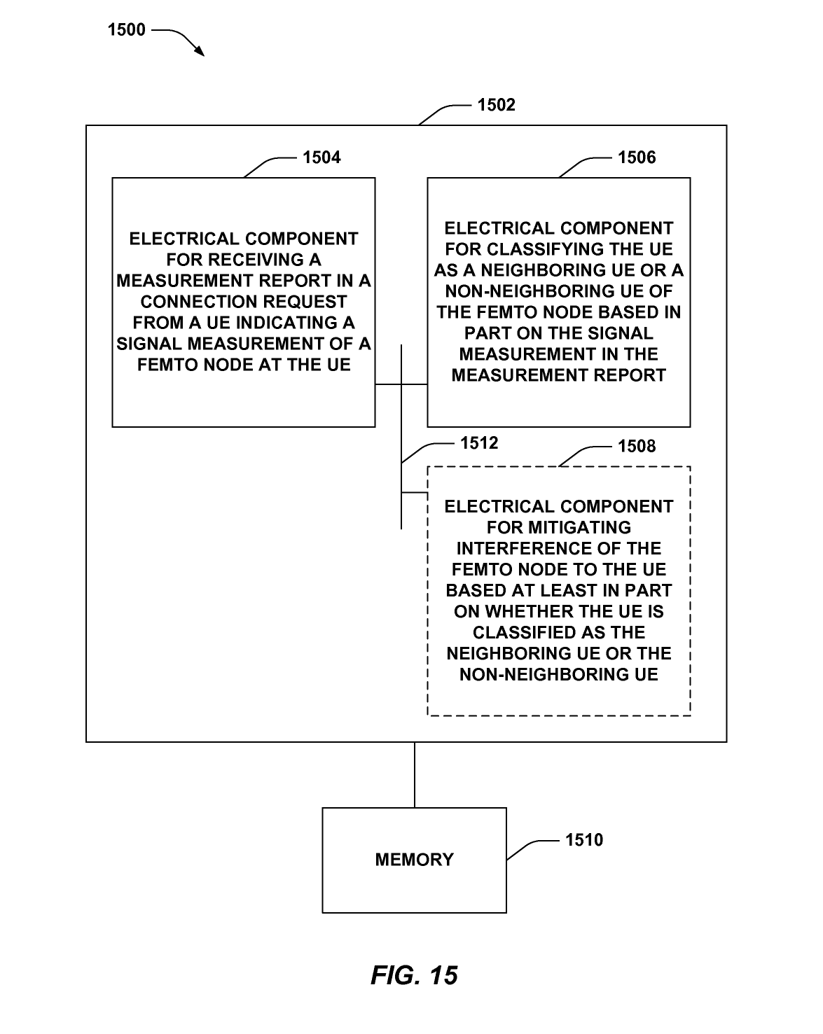

FIG. 15 illustrates a system 1500 for classifying UEs and mitigating interference thereto. For example, system 1500 can reside at least partially within a femto node or other low power base station. It is to be appreciated that system 1500 is represented as including functional blocks, which can be functional blocks that represent functions implemented by a processor, software, or combination thereof (e.g., firmware). System 1500 includes a logical grouping 1502 of electrical components that can act in conjunction. For instance, logical grouping 1502 can include an electrical component for receiving a measurement report in a connection request from a UE indicating a signal measurement of a femto node at the UE 1504. Further, logical grouping 1502 can include an electrical component for classifying the at least one UE as a neighboring UE or a non-neighboring UE of the femto node based in part on the signal measurement in the measurement report 1506.

As described, where in the signal measurement is near an expected coverage boundary measurement, this can indicate the UE may not frequently neighbor the femto node. For example, multiple measurements can be received and compared to classify the UE. Logical grouping 1502 can further optionally include an electrical component for mitigating interference of the femto node to the UE based at least in part on whether the UE is classified as the neighboring UE or the non-neighboring UE 1508. As described, this can include reducing a transmit power, allowing access to neighboring UEs, etc.

For example, electrical component 1504 can include measurement report receiving component 418, as described above. In addition, for example, electrical component 1506, in an aspect, can include a UE classifying component 410, and/or electrical component 1508 can include an interference mitigating component 212, as described.

Additionally, system 1500 can include a memory 1510 that retains instructions for executing functions associated with the electrical components 1504, 1506, and 1508. While shown as being external to memory 1510, it is to be understood that one or more of the electrical components 1504, 1506, and 1508 can exist within memory 1510. Moreover, for example, electrical components 1504, 1506, and 1508 can be interconnected by a bus 1512. In one example, electrical components 1504, 1506, and 1508 can include at least one processor, or each electrical component 1504, 1506, and 1508 can be a corresponding module of at least one processor. Moreover, in an additional or alternative example, electrical components 1504, 1506, and 1508 can be a computer program product comprising a computer readable medium, where each electrical component 1504, 1506, and 1508 can be corresponding code.

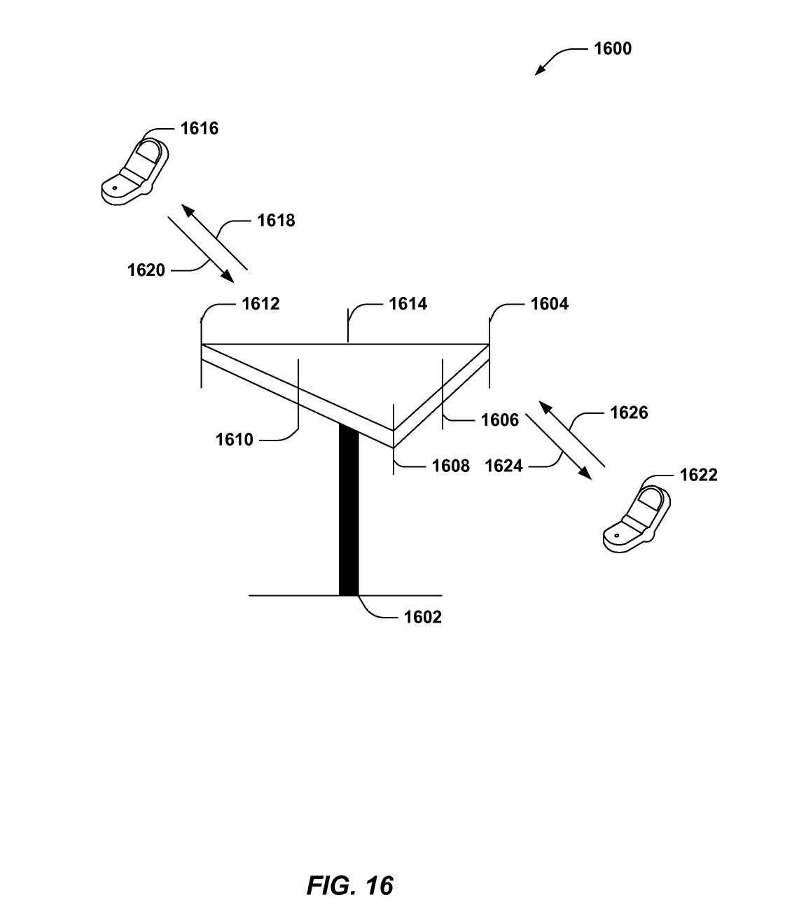

FIG. 16 illustrates a wireless communication system 1600 in accordance with various embodiments presented herein. System 1600 comprises a base station 1602 that can include multiple antenna groups. For example, one antenna group can include antennas 1604 and 1606, another group can comprise antennas 1608 and 1610, and an additional group can include antennas 1612 and 1614. Two antennas are illustrated for each antenna group; however, more or fewer antennas can be utilized for each group. Base station 1602 can additionally include a transmitter chain and a receiver chain, each of which can in turn comprise a plurality of components or modules associated with signal transmission and reception (e.g., processors, modulators, multiplexers, demodulators, demultiplexers, antennas, etc.), as is appreciated.

Base station 1602 can communicate with one or more mobile devices such as mobile device 1616 and mobile device 1622; however, it is to be appreciated that base station 1602 can communicate with substantially any number of mobile devices similar to mobile devices 1616 and 1622. Mobile devices 1616 and 1622 can be, for example, cellular phones, smart phones, laptops, handheld communication devices, handheld computing devices, satellite radios, global positioning systems, PDAs, and/or any other suitable device for communicating over wireless communication system 1600. As depicted, mobile device 1616 is in communication with antennas 1612 and 1614, where antennas 1612 and 1614 transmit information to mobile device 1616 over a forward link 1618 and receive information from mobile device 1616 over a reverse link 1620. Moreover, mobile device 1622 is in communication with antennas 1604 and 1606, where antennas 1604 and 1606 transmit information to mobile device 1622 over a forward link 1624 and receive information from mobile device 1622 over a reverse link 1626. In a frequency division duplex (FDD) system, forward link 1618 can utilize a different frequency band than that used by reverse link 1620, and forward link 1624 can employ a different frequency band than that employed by reverse link 1626, for example. Further, in a time division duplex (TDD) system, forward link 1618 and reverse link 1620 can utilize a common frequency band and forward link 1624 and reverse link 1626 can utilize a common frequency band.

Each group of antennas and/or the area in which they are designated to communicate can be referred to as a sector of base station 1602. For example, antenna groups can be designed to communicate to mobile devices in a sector of the areas covered by base station 1602. In communication over forward links 1618 and 1624, the transmitting antennas of base station 1602 can utilize beamforming to improve signal-to-noise ratio of forward links 1618 and 1624 for mobile devices 1616 and 1622. Also, while base station 1602 utilizes beamforming to transmit to mobile devices 1616 and 1622 scattered randomly through an associated coverage, mobile devices in neighboring cells can be subject to less interference as compared to a base station transmitting through a single antenna to all its mobile devices. Moreover, mobile devices 1616 and 1622 can communicate directly with one another using a peer-to-peer or ad hoc technology as depicted.

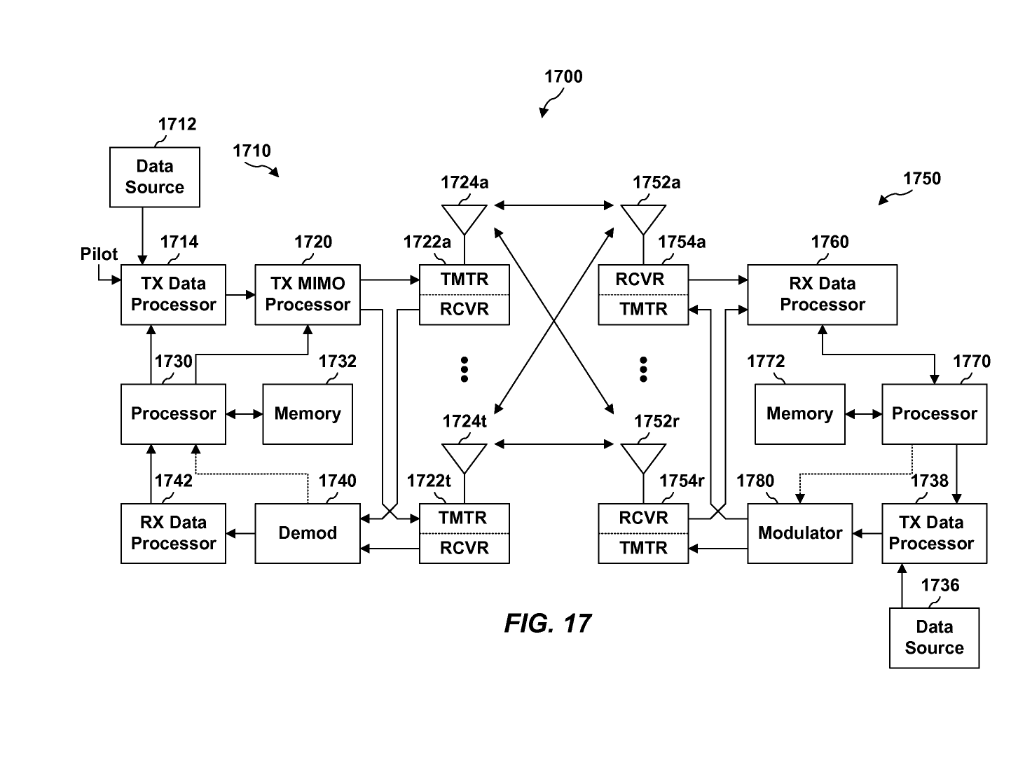

FIG. 17 shows an example wireless communication system 1700. The wireless communication system 1700 depicts one base station 1710 and one mobile device 1750 for sake of brevity. However, it is to be appreciated that system 1700 can include more than one base station and/or more than one mobile device, wherein additional base stations and/or mobile devices can be substantially similar or different from example base station 1710 and mobile device 1750 described below. Moreover, base station 1710 can be a low power base station, in one example, such as one or more femto nodes previously described. In addition, it is to be appreciated that base station 1710 and/or mobile device 1750 can employ the example systems (FIGS. 1-4 and 12-16), graphs (FIGS. 5-8), and/or methods (FIGS. 9-11) described herein to facilitate wireless communication there between. For example, components or functions of the systems and/or methods described herein can be part of a memory 1732 and/or 1772 or processors 1730 and/or 1770 described below, and/or can be executed by processors 1730 and/or 1770 to perform the disclosed functions.

At base station 1710, traffic data for a number of data streams is provided from a data source 1712 to a transmit (TX) data processor 1714. According to an example, each data stream can be transmitted over a respective antenna. TX data processor 1714 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1750 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1730.

The modulation symbols for the data streams can be provided to a TX MIMO processor 1720, which can further process the modulation symbols (e.g., for OFDM). TX MIMO processor 1720 then provides N_{T} modulation symbol streams to N_{T} transmitters (TMTR) 1722a through 1722t. In various embodiments, TX MIMO processor 1720 applies beamforming weights to the symbols of the data streams and to the antenna from which the symbol is being transmitted.

Each transmitter 1722 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1722a through 1722t are transmitted from N_{T} antennas 1724a through 1724t, respectively.

At mobile device 1750, the transmitted modulated signals are received by N_{R} antennas 1752a through 1752r and the received signal from each antenna 1752 is provided to a respective receiver (RCVR) 1754a through 1754r. Each receiver 1754 conditions (e.g., filters, amplifies, and downconverts) a respective signal, digitizes the conditioned signal to provide samples, and further processes the samples to provide a corresponding “received” symbol stream.

An RX data processor 1760 can receive and process the N_{R} received symbol streams from N_{R} receivers 1754 based on a particular receiver processing technique to provide N_{T} “detected” symbol streams. RX data processor 1760 can demodulate, deinterleave, and decode each detected symbol stream to recover the traffic data for the data stream. The processing by RX data processor 1760 is complementary to that performed by TX MIMO processor 1720 and TX data processor 1714 at base station 1710.

The reverse link message can comprise various types of information regarding the communication link and/or the received data stream. The reverse link message can be processed by a TX data processor 1738, which also receives traffic data for a number of data streams from a data source 1736, modulated by a modulator 1780, conditioned by transmitters 1754a through 1754r, and transmitted back to base station 1710.

At base station 1710, the modulated signals from mobile device 1750 are received by antennas 1724, conditioned by receivers 1722, demodulated by a demodulator 1740, and processed by a RX data processor 1742 to extract the reverse link message transmitted by mobile device 1750. Further, processor 1730 can process the extracted message to determine which precoding matrix to use for determining the beamforming weights.

Processors 1730 and 1770 can direct (e.g., control, coordinate, manage, etc.) operation at base station 1710 and mobile device 1750, respectively. Respective processors 1730 and 1770 can be associated with memory 1732 and 1772 that store program codes and data. For example, processor 1730 and/or 1770 can execute, and/or memory 1732 and/or 1772 can store instructions related to functions and/or components described herein, such as classifying UEs for mitigating interference thereto, and/or the like, as described.

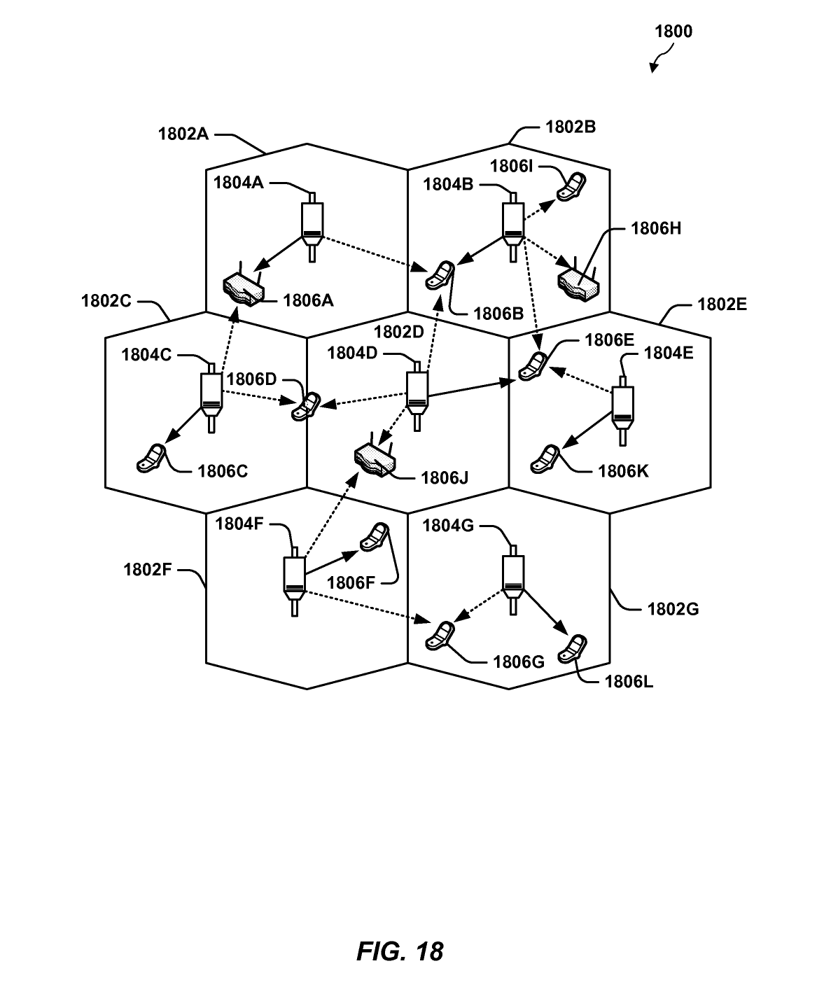

FIG. 18 illustrates a wireless communication system 1800, configured to support a number of users, in which the teachings herein may be implemented. The system 1800 provides communication for multiple cells 1802, such as, for example, macro cells 1802A-1802G, with each cell being serviced by a corresponding access node 1804 (e.g., access nodes 1804A-1804G). As shown in FIG. 18, access terminals 1806 (e.g., access terminals 1806A-1806L) can be dispersed at various locations throughout the system over time. Each access terminal 1806 can communicate with one or more access nodes 1804 on a forward link (FL) and/or a reverse link (RL) at a given moment, depending upon whether the access terminal 1806 is active and whether it is in soft handoff, for example. The wireless communication system 1800 can provide service over a large geographic region.

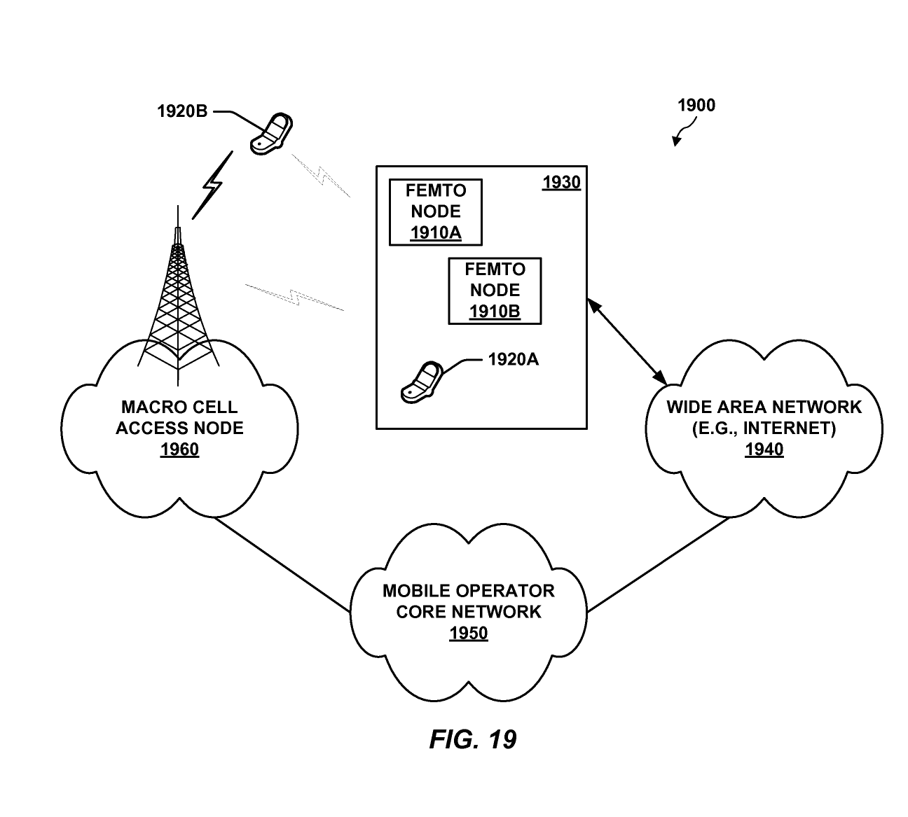

FIG. 19 illustrates an exemplary communication system 1900 where one or more femto nodes are deployed within a network environment. Specifically, the system 1900 includes multiple femto nodes 1910A and 1910B (e.g., femtocell nodes or H(e)NB) installed in a relatively small scale network environment (e.g., in one or more user residences 1930). Each femto node 1910 can be coupled to a wide area network 1940 (e.g., the Internet) and a mobile operator core network 1950 via a digital subscriber line (DSL) router, a cable modem, a wireless link, or other connectivity means (not shown). As will be discussed below, each femto node 1910 can be configured to serve associated access terminals 1920 (e.g., access terminal 1920A) and, optionally, alien access terminals 1920 (e.g., access terminal 1920B). In other words, access to femto nodes 1910 can be restricted such that a given access terminal 1920 can be served by a set of designated (e.g., home) femto node(s) 1910 but may not be served by any non-designated femto nodes 1910 (e.g., a neighbor's femto node).

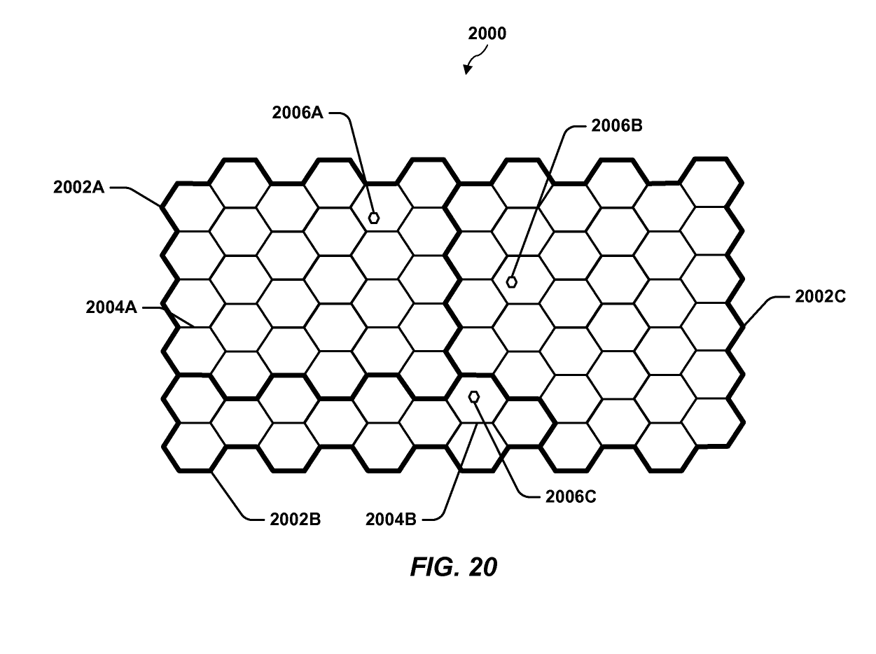

FIG. 20 illustrates an example of a coverage map 2000 where several tracking areas 2002 (or routing areas or location areas) are defined, each of which includes several macro coverage areas 2004. Here, areas of coverage associated with tracking areas 2002A, 2002B, and 2002C are delineated by the wide lines and the macro coverage areas 2004 are represented by the hexagons. The tracking areas 2002 also include femto coverage areas 2006. In this example, each of the femto coverage areas 2006 (e.g., femto coverage area 2006C) is depicted within a macro coverage area 2004 (e.g., macro coverage area 2004B). It should be appreciated, however, that a femto coverage area 2006 may not lie entirely within a macro coverage area 2004. In practice, a large number of femto coverage areas 2006 can be defined with a given tracking area 2002 or macro coverage area 2004. Also, one or more pico coverage areas (not shown) can be defined within a given tracking area 2002 or macro coverage area 2004.

Referring again to FIG. 19, the owner of a femto node 1910 can subscribe to mobile service, such as, for example, 3G mobile service, offered through the mobile operator core network 1950. In addition, an access terminal 1920 can be capable of operating both in macro environments and in smaller scale (e.g., residential) network environments. Thus, for example, depending on the current location of the access terminal 1920, the access terminal 1920 can be served by an access node 1960 or by any one of a set of femto nodes 1910 (e.g., the femto nodes 1910A and 1910B that reside within a corresponding user residence 1930). For example, when a subscriber is outside his home, he is served by a standard macro cell access node (e.g., node 1960) and when the subscriber is at home, he is served by a femto node (e.g., node 1910A). Here, it should be appreciated that a femto node 1910 can be backward compatible with existing access terminals 1920.

A femto node 1910 can be deployed on a single frequency or, in the alternative, on multiple frequencies. Depending on the particular configuration, the single frequency or one or more of the multiple frequencies can overlap with one or more frequencies used by a macro cell access node (e.g., node 1960). In some aspects, an access terminal 1920 can be configured to connect to a preferred femto node (e.g., the home femto node of the access terminal 1920) whenever such connectivity is possible. For example, whenever the access terminal 1920 is within the user's residence 1930, it can communicate with the home femto node 1910.

In some aspects, if the access terminal 1920 operates within the mobile operator core network 1950 but is not residing on its most preferred network (e.g., as defined in a preferred roaming list), the access terminal 1920 can continue to search for the most preferred network (e.g., femto node 1910) using a Better System Reselection (BSR), which can involve a periodic scanning of available systems to determine whether better systems are currently available, and subsequent efforts to associate with such preferred systems. Using an acquisition table entry (e.g., in a preferred roaming list), in one example, the access terminal 1920 can limit the search for specific band and channel. For example, the search for the most preferred system can be repeated periodically. Upon discovery of a preferred femto node, such as femto node 1910, the access terminal 1920 selects the femto node 1910 for camping within its coverage area.

A femto node can be restricted in some aspects. For example, a given femto node can only provide certain services to certain access terminals. In deployments with so-called restricted (or closed) association, a given access terminal can only be served by the macro cell mobile network and a defined set of femto nodes (e.g., the femto nodes 1910 that reside within the corresponding user residence 1930). In some implementations, a femto node can be restricted to not provide, for at least one access terminal, at least one of: signaling, data access, registration, paging, or service.

In some aspects, a restricted femto node (which can also be referred to as a Closed Subscriber Group H(e)NB) is one that provides service to a restricted provisioned set of access terminals. This set can be temporarily or permanently extended as necessary. In some aspects, a Closed Subscriber Group (CSG) can be defined as the set of access nodes (e.g., femto nodes) that share a common access control list of access terminals. A channel on which all femto nodes (or all restricted femto nodes) in a region operate can be referred to as a femto channel.

Various relationships can thus exist between a given femto node and a given access terminal. For example, from the perspective of an access terminal, an open femto node can refer to a femto node with no restricted association. A restricted femto node can refer to a femto node that is restricted in some manner (e.g., restricted for association and/or registration). A home femto node can refer to a femto node on which the access terminal is authorized to access and operate on. A guest femto node can refer to a femto node on which an access terminal is temporarily authorized to access or operate on. An alien femto node can refer to a femto node on which the access terminal is not authorized to access or operate on (e.g., the access terminal is a non-member), except for perhaps emergency situations (e.g., 911 calls).

From a restricted femto node perspective, a home access terminal can refer to an access terminal that authorized to access the restricted femto node. A guest access terminal can refer to an access terminal with temporary access to the restricted femto node. An alien access terminal can refer to an access terminal that does not have permission to access the restricted femto node, except for perhaps emergency situations, for example, 911 calls (e.g., an access terminal that does not have the credentials or permission to register with the restricted femto node).

For convenience, the disclosure herein describes various functionality in the context of a femto node. It should be appreciated, however, that a pico node can provide the same or similar functionality as a femto node, but for a larger coverage area. For example, a pico node can be restricted, a home pico node can be defined for a given access terminal, and so on.

A wireless multiple-access communication system can simultaneously support communication for multiple wireless access terminals. As mentioned above, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out system, a MIMO system, or some other type of system.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for classifying user equipment (UE) at a femto node, comprising:
temporarily modifying an advertised paging area identifier of a femto node for a plurality of durations of time to cause one or more UEs to attempt registration;
determining a number of registration requests received from at least one of the one or more UEs during the plurality of durations of time; and
classifying the at least one UE as a neighboring UE or a non-neighboring UE of the femto node based in part on the number of registration requests.

2. The method of claim 1, further comprising responding to the registration requests received from the at least one UE with a release message indicating a cause of congestion.

3. The method of claim 1, wherein the classifying the at least one UE is based in part on comparing the number of registration requests to a threshold relative to a number of the plurality of durations of time.

4. The method of claim 1, further comprising mitigating interference of the femto node to the UE based at least in part on whether the UE is classified as the neighboring UE or the non-neighboring UE.

5. The method of claim 4, wherein the mitigating interference comprises modifying a transmission power of the femto node.

6. The method of claim 4, wherein the mitigating interference comprises modifying a level of access provided to the UE at the femto node.

7. The method of claim 1, further comprising:
receiving a page or a location update request for a served UE during at least one of the plurality of durations of time; and
switching to an original paging area identifier during the at least one of the plurality of durations of time based in part on the page or the location update request.

8. The method of claim 1, wherein the advertised paging area identifier corresponds to a location area code, routing area code, or tracking area code.

9. The method of claim 1, wherein the temporarily modifying the advertised paging area identifier comprises modifying the advertised paging area identifier according to a periodic time interval, a non-periodic time interval, or based on one or more UE-specified events.

10. An apparatus for classifying user equipment (UE) at a femto node, comprising:
at least one processor configured to:
temporarily modify an advertised paging area identifier of a femto node for a plurality of durations of time to cause one or more UEs to attempt registration;
determine a number of registration requests received from at least one of the one or more UEs during the plurality of durations of time; and
classify the at least one UE as a neighboring UE or a non-neighboring UE of the femto node based in part on the number of registration requests; and
a memory coupled to the at least one processor.

11. The apparatus of claim 10, wherein the at least one processor is further configured to respond to the registration requests received from the at least one UE with a release message indicating a cause of congestion.

12. The apparatus of claim 10, wherein the at least one processor classifies the at least one UE based in part on comparing the number of registration requests to a threshold relative to a number of the plurality of durations of time.

13. The apparatus of claim 10, wherein the at least one processor is further configured to mitigate interference of the femto node to the UE based at least in part on whether the UE is classified as the neighboring UE or the non-neighboring UE.

14. The apparatus of claim 13, wherein the at least one processor mitigates interference in part by modifying a transmission power of the femto node.

15. The apparatus of claim 13, wherein the at least one processor mitigates interference in part by modifying a level of access provided to the UE at the femto node.

16. The apparatus of claim 10, wherein the at least one processor is further configured to:
receive a page or a location update request for a served UE during at least one of the plurality of durations of time; and
switch to an original paging area identifier during at least one of the plurality of durations of time based in part on the page or the location update request.

17. The apparatus of claim 10, wherein the advertised paging area identifier corresponds to a location area code, routing area code, or tracking area code.

18. The apparatus of claim 10, wherein the at least one processor temporarily modifies the advertised paging area identifier according to a periodic time interval, a non-periodic time interval, or based on one or more UE-specified events.

19. An apparatus for classifying user equipment (UE) at a femto node, comprising:
means for temporarily modifying an advertised paging area identifier of a femto node for a plurality of durations of time to cause one or more UEs to attempt registration;
means for determining a number of registration requests received from at least one of the one or more UEs during the plurality of durations of time; and
means for classifying the at least one UE as a neighboring UE or a non-neighboring UE of the femto node based in part on the number of registration requests.

20. The apparatus of claim 19, wherein the means for determining responds to the registration requests received from the at least one UE with a release message indicating a cause of congestion.

21. The apparatus of claim 19, wherein the means for classifying classifies the at least one UE based in part on comparing the number of registration requests to a threshold relative to a number of the plurality of durations of time.

22. The apparatus of claim 19, further comprising means for mitigating interference of the femto node to the UE based at least in part on whether the UE is classified as the neighboring UE or the non-neighboring UE.

23. The apparatus of claim 22, wherein the means for mitigating mitigates interference in part by modifying a transmission power of the femto node.

24. The apparatus of claim 22, wherein the means for mitigating mitigates interference in part by modifying a level of access provided to the UE at the femto node.

25. The apparatus of claim 19, wherein the means for periodically modifying the advertised paging area identifier switches to an original paging area identifier during at least one of the plurality of durations of time based in part on a page or a location update request received for a served UE.

26. The apparatus of claim 19, wherein the advertised paging area identifier corresponds to a location area code, routing area code, or tracking area code.

27. The apparatus of claim 19, wherein the means for temporarily modifying temporarily modifies the advertised paging area identifier according to a periodic time interval, a non-periodic time interval, or based on one or more UE-specified events.

28. A computer program product for classifying user equipment (UE) at a femto node, comprising:
a non-transitory computer-readable medium, comprising:
code for causing at least one computer to temporarily modify an advertised paging area identifier of a femto node for a plurality of durations of time to cause one or more UEs to attempt registration;
code for causing the at least one computer to determine a number of registration requests received from at least one of the one or more UEs during the plurality of durations of time; and
code for causing the at least one computer to classify the at least one UE as a neighboring UE or a non-neighboring UE of the femto node based in part on the number of registration requests.

29. The computer program product of claim 28, wherein the computer-readable medium further comprises code for causing the at least one computer to respond to the registration requests received from the at least one UE with a release message indicating a cause of congestion.

30. The computer program product of claim 28, wherein the code for causing the at least one computer to classify classifies the at least one UE based in part on comparing the number of registration requests to a threshold relative to a number of the plurality of durations of time.

31. The computer program product of claim 28, wherein the computer-readable medium further comprises code for causing the at least one computer to mitigate interference of the femto node to the UE based at least in part on whether the UE is classified as the neighboring UE or the non-neighboring UE.

32. The computer program product of claim 31, wherein the code for causing the at least one computer to mitigate mitigates interference in part by modifying a transmission power of the femto node.

33. The computer program product of claim 31, wherein the code for causing the at least one computer to mitigate mitigates the interference in part by modifying a level of access provided to the UE at the femto node.

34. The computer program product of claim 28, wherein the computer-readable medium further comprises:
code for causing the at least one computer to receive a page or a location update request for a served UE during at least one of the plurality of durations of time; and
code for causing the at least one computer to switch to an original paging area identifier during at least one of the plurality of durations of time based in part on the page or the location update request.

35. The computer program product of claim 28, wherein the advertised paging area identifier corresponds to a location area code, routing area code, or tracking area code.

36. The computer program product of claim 28, wherein the code for causing the at least one computer to temporarily modify temporarily modifies the advertised paging area identifier according to a periodic time interval, a non-periodic time interval, or based on one or more UE-specified events.

37. An apparatus for classifying user equipment (UE) at a femto node, comprising:
an identifier modifying component for temporarily modifying an advertised paging area identifier of a femto node for a plurality of durations of time to cause one or more UEs to attempt registration;
a UE registration receiving component for determining a number of registration requests received from at least one of the one or more UEs during the plurality of durations of time; and
a UE classifying component for classifying the at least one UE as a neighboring UE or a non-neighboring UE of the femto node based in part on the number of registration requests.

38. The apparatus of claim 37, wherein the UE registration receiving component responds to the registration requests received from the at least one UE with a release message indicating a cause of congestion.

39. The apparatus of claim 37, wherein the UE classifying component classifies the at least one UE based in part on comparing the number of registration requests to a threshold relative to a number of the plurality of durations of time.

40. The apparatus of claim 37, further comprising an interference mitigating component for mitigating interference of the femto node to the UE based at least in part on whether the UE is classified as the neighboring UE or the non-neighboring UE.

41. The apparatus of claim 40, wherein the interference mitigating component mitigates interference in part by modifying a transmission power of the femto node.

42. The apparatus of claim 40, wherein the interference mitigating component mitigates interference in part by modifying a level of access provided to the UE at the femto node.

43. The apparatus of claim 37, wherein the identifier modifying component switches to an original paging area identifier during at least one of the plurality of durations of time based in part on a page or a location update request received for a served UE.

44. The apparatus of claim 37, wherein the advertised paging area identifier corresponds to a location area code, routing area code, or tracking area code.

45. The apparatus of claim 37, wherein the identifier modifying component temporarily modifies the advertised paging area identifier according to a periodic time interval, a non-periodic time interval, or based on one or more UE-specified events.

46. A method for classifying user equipment (UE) at a femto node, comprising:
measuring one or more time intervals between a plurality of registration requests received from a UE at a femto node; and
classifying the UE as a neighboring UE or a non-neighboring UE of the femto node based in part on comparing the one or more time intervals.

47. The method of claim 46, wherein the classifying the UE is based on determining whether at least a portion of the one or more time intervals are within a threshold difference of one another.

48. The method of claim 46, further comprising comparing the one or more time intervals to a forbidden list timer value, wherein the classifying is based in part on determining whether the one or more time intervals are within a threshold difference of the forbidden list timer value.

49. The method of claim 46, further comprising mitigating interference of the femto node to the UE based at least in part on whether the UE is classified as the neighboring UE or the non-neighboring UE.

50. The method of claim 49, wherein the mitigating interference comprises modifying a transmission power of the femto node or modifying a level of access provided to the UE at the femto node.

51. An apparatus for classifying user equipment (UE) at a femto node, comprising:
at least one processor configured to:
measure one or more time intervals between a plurality of registration requests received from a UE at a femto node; and
classify the UE as a neighboring UE or a non-neighboring UE of the femto node based in part on comparing the one or more time intervals; and
a memory coupled to the at least one processor.

52. The apparatus of claim 51, wherein the at least one processor classifies the UE based on determining whether at least a portion of the one or more time intervals are within a threshold difference of one another.

53. The apparatus of claim 51, wherein the at least one processor is further configured to compare the one or more time intervals to a forbidden list timer value, wherein the at least one processor classifies based in part on determining whether the one or more time intervals are within a threshold difference of the forbidden list timer value.

54. The apparatus of claim 51, wherein the at least one processor is further configured to mitigate interference of the femto node to the UE based at least in part on whether the UE is classified as the neighboring UE or the non-neighboring UE.

55. The apparatus of claim 54, wherein the at least one processor mitigates interference at least in part by modifying a transmission power of the femto node or modifying a level of access provided to the UE at the femto node.

56. An apparatus for classifying user equipment (UE) at a femto node, comprising:
means for measuring one or more time intervals between a plurality of registration requests received from a UE at a femto node; and
means for classifying the UE as a neighboring UE or a non-neighboring UE of the femto node based in part on comparing the one or more time intervals.

57. The apparatus of claim 56, wherein the means for classifying classifies the UE based on determining whether at least a portion of the one or more time intervals are within a threshold difference of one another.

58. The apparatus of claim 56, wherein the means for classifying compares the one or more time intervals to a forbidden list timer value, and classifies based in part on determining whether the one or more time intervals are within a threshold difference of the forbidden list timer value.

59. The apparatus of claim 56, further comprising means for mitigating interference of the femto node to the UE based at least in part on whether the UE is classified as the neighboring UE or the non-neighboring UE.

60. The apparatus of claim 59, wherein the means for mitigating interference mitigates interference at least in part by modifying a transmission power of the femto node or modifying a level of access provided to the UE at the femto node.

61. A computer program product for classifying user equipment (UE) at a femto node, comprising:
a non-transitory computer-readable medium, comprising:
code for causing at least one computer to measure one or more time intervals between a plurality of registration requests received from a UE at a femto node; and
code for causing the at least one computer to classify the UE as a neighboring UE or a non-neighboring UE of the femto node based in part on comparing the one or more time intervals.

62. The computer program product of claim 61, wherein the code for causing the at least one computer to classify classifies the UE based on determining whether at least a portion of the one or more time intervals are within a threshold difference of one another.

63. The computer program product of claim 61, wherein the computer-readable medium further comprises code for causing the at least one computer to compare the one or more time intervals to a forbidden list timer value, and wherein the code for causing the at least one computer to classify classifies based in part on determining whether the one or more time intervals are within a threshold difference of the forbidden list timer value.

64. The computer program product of claim 61, wherein the computer-readable medium further comprises code for causing the at least one computer to mitigate interference of the femto node to the UE based at least in part on whether the UE is classified as the neighboring UE or the non-neighboring UE.

65. The computer program product of claim 64, wherein the code for causing the at least one computer to mitigate interference mitigates interference at least in part by modifying a transmission power of the femto node or modifying a level of access provided to the UE at the femto node.

66. An apparatus for classifying user equipment (UE) at a femto node, comprising:
a UE registration receiving component for measuring one or more time intervals between a plurality of registration requests received from a UE at a femto node; and
a UE classifying component for classifying the UE as a neighboring UE or a non-neighboring UE of the femto node based in part on comparing the one or more time intervals.

67. The apparatus of claim 66, wherein the UE classifying component classifies the UE based on determining whether at least a portion of the one or more time intervals are within a threshold difference of one another.

68. The apparatus of claim 66, wherein the UE classifying component compares the one or more time intervals to a forbidden list timer value, and classifies based in part on determining whether the one or more time intervals are within a threshold difference of the forbidden list timer value.

69. The apparatus of claim 66, further comprising an interference mitigating component for mitigating interference of the femto node to the UE based at least in part on whether the UE is classified as the neighboring UE or the non-neighboring UE.

70. The apparatus of claim 69, wherein the interference mitigating component mitigates interference at least in part by modifying a transmission power of the femto node or modifying a level of access provided to the UE at the femto node.

71. A method for classifying user equipment (UE) at a femto node, comprising:
receiving a measurement report in a connection request from a UE indicating a signal measurement of a femto node at the UE; and
classifying the UE as a neighboring UE or a non-neighboring UE of the femto node based in part on the signal measurement in the measurement report.

72. The method of claim 71, further comprising comparing the signal measurement to a threshold corresponding to a coverage boundary measurement, wherein the classifying the UE is based on determining a difference between the signal measurement and the threshold.

73. The method of claim 72, further comprising comparing additional signal measurements received in additional measurement reports from the UE to the coverage boundary measurement, wherein the classifying the UE is based on determining a difference between the additional signal measurements and the threshold.

74. The method of claim 71, further comprising mitigating interference of the femto node to the UE based at least in part on whether the UE is classified as the neighboring UE or the non-neighboring UE.

75. The method of claim 74, wherein the mitigating interference comprises modifying a transmission power of the femto node or modifying a level of access provided to the UE at the femto node.

76. An apparatus for classifying user equipment (UE) at a femto node, comprising:
at least one processor configured to:
receive a measurement report in a connection request from a UE indicating a signal measurement of a femto node at the UE; and
classify the UE as a neighboring UE or a non-neighboring UE of the femto node based in part on the signal measurement in the measurement report; and
a memory coupled to the at least one processor.

77. The apparatus of claim 76, wherein the at least one processor is further configured to compare the signal measurement to a threshold corresponding to a coverage boundary measurement, and wherein the at least one processor classifies the UE based on determining a difference between the signal measurement and the threshold.

78. The apparatus of claim 77, wherein the at least one processor is further configured to compare additional signal measurements received in additional measurement reports from the UE to the coverage boundary measurement, and wherein the at least one processor classifies the UE based on determining a difference between the additional signal measurements and the threshold.

79. The apparatus of claim 76, wherein the at least one processor is further configured to mitigate interference of the femto node to the UE based at least in part on whether the UE is classified as the neighboring UE or the non-neighboring UE.

80. The apparatus of claim 79, wherein the at least one processor mitigates interference at least in part by modifying a transmission power of the femto node or modifying a level of access provided to the UE at the femto node.

81. An apparatus for classifying user equipment (UE) at a femto node, comprising:
means for receiving a measurement report in a connection request from a UE indicating a signal measurement of a femto node at the UE; and
means for classifying the UE as a neighboring UE or a non-neighboring UE of the femto node based in part on the signal measurement in the measurement report.

82. The apparatus of claim 81, wherein the means for classifying compares the signal measurement to a threshold corresponding to a coverage boundary measurement, and classifies the UE based on determining a difference between the signal measurement and the threshold.

83. The apparatus of claim 82, wherein the means for classifying compares additional signal measurements received in additional measurement reports from the UE to the coverage boundary measurement, and classifies the UE based on determining a difference between the additional signal measurements and the threshold.

84. The apparatus of claim 81, further comprising means for mitigating interference of the femto node to the UE based at least in part on whether the UE is classified as the neighboring UE or the non-neighboring UE.

85. The apparatus of claim 84, wherein the means for mitigating interference mitigates interference at least in part by modifying a transmission power of the femto node or modifying a level of access provided to the UE at the femto node.

86. A computer program product for classifying user equipment (UE) at a femto node, comprising:
a non-transitory computer-readable medium, comprising:
code for causing at least one computer to receive a measurement report in a connection request from a UE indicating a signal measurement of a femto node at the UE; and
code for causing the at least one computer to classify the UE as a neighboring UE or a non-neighboring UE of the femto node based in part on the signal measurement in the measurement report.

87. The computer program product of claim 86, wherein the computer-readable medium further comprises code for causing the at least one computer to compare the signal measurement to a threshold corresponding to a coverage boundary measurement, and wherein the code for causing the at least one computer to classify classifies the UE based on determining a difference between the signal measurement and the threshold.

88. The computer program product of claim 87, wherein the computer-readable medium further comprises code for causing the at least one computer to compare additional signal measurements received in additional measurement reports from the UE to the coverage boundary measurement, and wherein the code for causing the at least one computer to classify classifies the UE based on determining a difference between the additional signal measurements and the threshold.

89. The computer program product of claim 86, wherein the computer-readable medium further comprises code for causing the at least one computer to mitigate interference of the femto node to the UE based at least in part on whether the UE is classified as the neighboring UE or the non-neighboring UE.

90. The computer program product of claim 89, wherein the code for causing the at least one computer to mitigate interference mitigates interference at least in part by modifying a transmission power of the femto node or modifying a level of access provided to the UE at the femto node.

91. An apparatus for classifying user equipment (UE) at a femto node, comprising:
a measurement report receiving component for receiving a measurement report in a connection request from a UE indicating a signal measurement of a femto node at the UE; and
a UE classifying component for classifying the UE as a neighboring UE or a non-neighboring UE of the femto node based in part on the signal measurement in the measurement report.

92. The apparatus of claim 91, wherein the UE classifying component compares the signal measurement to a threshold corresponding to a coverage boundary measurement, and classifies the UE based on determining a difference between the signal measurement and the threshold.

93. The apparatus of claim 92, wherein the UE classifying component compares additional signal measurements received in additional measurement reports from the UE to the coverage boundary measurement, and classifies the UE based on determining a difference between the additional signal measurements and the threshold.

94. The apparatus of claim 91, further comprising an interference mitigating component for mitigating interference of the femto node to the UE based at least in part on whether the UE is classified as the neighboring UE or the non-neighboring UE.

95. The apparatus of claim 94, wherein the interference mitigating component mitigates interference at least in part by modifying a transmission power of the femto node or modifying a level of access provided to the UE at the femto node.
